(19) United States
(12) Patent Application Publication
(10) Pub. No.: US 2023/0045194 A1
(43) Pub. Date: Feb. 9, 2023

(54) COMBINED HOT WATER DISPENSER AND BEVERAGE BREWER

(71) Applicant: Amir Armin, Tehran (IR)

(72) Inventor: Amir Armin, Tehran (IR)

(73) Assignee: Amir Armin, Tehran (IR)

(21) Appl. No.: 17/903,979

(22) Filed: Sep. 6, 2022

Related U.S. Application Data
(63) Continuation-in-part of application No. PCT/IB2020/061897, filed on Dec. 14, 2020.

(51) Int. Cl. A47J 31/54; A47J 31/10; A47J 31/46; A47J 31/52

(52) U.S. Cl. CPC A47J 31/545; A47J 31/106; A47J 31/462; A47J 31/461; A47J 31/5253

(57) ABSTRACT

A combined hot water dispenser and beverage brewer. The combined hot water dispenser and beverage brewer includes a water heating section and a water storage section. The water heating section includes a boiler reservoir, a heating element, a first water discharge mechanism, and a second discharge mechanism. The water storage section includes a cold water reservoir and a hot water reservoir disposed above the boiler reservoir.

### CROSS-REFERENCE TO RELATED APPLICATION

This application is a continuation-in-part of international Application PCT/IB2020/061897, filed on Dec. 14, 2020, and entitled “COMBINED HOT WATER DISPENSER AND BEVERAGE BREWER,” which is incorporated herein by reference in its entirety.

### TECHNICAL FIELD

The present disclosure generally relates to kitchen appliances and, particularly, relates to tea/coffee brewing devices and hot water dispensers and, more particularly, relates to a combined hot water dispenser and beverage brewer.

### BACKGROUND

Brewed tea and coffee are traditionally prepared through first boiling an amount of water and then pouring the boiling water into a pot holding coffee and/or tea infuser, ball, or bag. The coffee or tea are allowed to steep whereupon flavor is extracted from the coffee grains or tea leaves into the water. The strength of the flavor of the coffee or tea may primarily be dependent upon the length of the steeping period and the temperature of the water.

Traditional brewing devices may have some issues. For example, traditional brewing devices do not provide precise control of the temperature of the dispensed water and the length of the steeping period. Furthermore, these devices do not provide a facility for a user to receive hot water in addition to brewed tea or coffee and may also heat a large amount of water to prepare just one cup of tea or coffee. Hence they may consume a lot of unnecessary energy. There is, therefore, a need for a brewing device that is able to provide a facility for a user to control the temperature of the dispensed water and the length of the steeping period as well as the amount of the heated water used for brewing to optimize the energy consumption and provide a user with as much beverage as the user may need. There is also a need for a brewing device that can prepare and dispense hot water in addition to brewing tea or coffee.

### SUMMARY OF THE DISCLOSURE

This summary is intended to provide an overview of the subject matter of the present disclosure, and is not intended to identify essential elements or key elements of the subject matter, nor is it intended to be used to determine the scope of the claimed implementations. The proper scope of the present disclosure may be ascertained from the claims set forth below in view of the detailed description below and the drawings.

In one general aspect, the present disclosure describes a combined hot water dispenser and beverage brewer. In an exemplary embodiment, the disclosed combined hot water dispenser and beverage brewer may include a water heating section, a water storage section, a delivery section, and a user interface combined with control section. In an exemplary embodiment, the water heating section may include a boiler reservoir, a first temperature sensor, a heating element, a first water discharge mechanism, and a second water discharge mechanism.

In an exemplary embodiment, the boiler reservoir may be configured to receive and store water. In an exemplary embodiment, the heating element may be disposed inside the boiler reservoir. In an exemplary embodiment, the heating element may be configured to heat water inside the boiler reservoir.

In an exemplary embodiment, the first water discharge mechanism may be configured to discharge water from the boiler reservoir. In an exemplary embodiment, the first water discharge mechanism may include a first discharge faucet and a first discharge tube. In an exemplary embodiment, the first discharge faucet may be disposed under the boiler reservoir.

In an exemplary embodiment, a bottom end of the first discharge tube may be connected to the first discharge faucet. In an exemplary embodiment, the top end of the first discharge tube may be disposed at a top end of the boiler reservoir. In an exemplary embodiment, the first discharge faucet may be configured to allow water discharge from the top end of the boiler reservoir and through the first discharge tube.

In an exemplary embodiment, the water storage section may include a cold water reservoir and a hot water reservoir. In an exemplary embodiment, the cold water reservoir may be configured to receive and store water. In an exemplary embodiment, the cold water reservoir may be disposed above the boiler reservoir. In an exemplary embodiment, the cold water reservoir may be in fluid communication with the bottom end of the boiler reservoir through a cold water inlet.

In an exemplary embodiment, the hot water reservoir may be configured to receive and store water. In an exemplary embodiment, the hot water reservoir may be in fluid communication with the top end of the boiler reservoir through a hot water inlet. In an exemplary embodiment, the hot water reservoir may be disposed above the boiler reservoir.

In an exemplary embodiment, the delivery section may be disposed under the water heating section. In an exemplary embodiment, the delivery section may include a beverage brewing section and a hot water delivery section.

In an exemplary embodiment, the beverage brewing section may be associated with the first water discharge mechanism. In an exemplary embodiment, the beverage brewing section may be disposed under the first discharge faucet. In an exemplary embodiment, the beverage brewing section may include a beverage heating mechanism.

In an exemplary embodiment, the beverage heating mechanism may be configured to receive a beverage container, secure the beverage container under the first discharge faucet, and heat the beverage container. In an exemplary embodiment, the first discharge faucet may be configured to allow water discharge from the top end of the boiler reservoir and through the first discharge tube into the beverage container. In an exemplary embodiment, when the beverage container is disposed onto the beverage heating mechanism by a user, the presence of the beverage container may be detected by utilizing a micro switch. In an exemplary embodiment, the micro switch may be configured to send a signal to the controller when the presence of the beverage container is not detected by the micro switch. In an exemplary embodiment, the controller may be configured to prevent the first water discharge mechanism to discharge water in absence of the beverage container.

In an exemplary embodiment, hot water delivery section may be associated with the second water discharge mechanism. In an exemplary embodiment, the hot water delivery section may be disposed under the second discharge faucet. In an exemplary embodiment, the hot water delivery section may include a water container holding member. In an exemplary embodiment, the water container holding member may be configured to receive a water container and secure the water container under the second discharge faucet. In an exemplary embodiment, the water container holding member may further be configured to temporarily store a first amount of waste water. In an exemplary embodiment, it may be understood that the first amount of waste water may be poured into the water container holding member by the user or when the water is overfilled in the water container. In an exemplary embodiment, the second discharge faucet may be configured to allow water discharge from the top end of the boiler reservoir and through the second discharge tube into the water container.

In an exemplary embodiment, the user interface and control section may be configured to receive feedbacks, commands, and adjustments from a user. In an exemplary embodiment, the user interface and control section may further be configured to control some functions of the combined hot water dispenser and beverage brewer based on the feedbacks received from temperature sensors and micro switches.

In an exemplary embodiment, the user interface and control section may be fully electronic. In this embodiment, the user interface and control section may be able to switch on/off the heaters, the light sources, and the alarm using a plurality of electronic devices and on a closed-loop basis making use of feedbacks received from temperature sensors and micro switches. In this embodiment, a screen may be used to indicate adjustments made by user using some numbers, some figures, and some icons. In an exemplary embodiment, in order to receive these adjustments from a user, a plurality of push buttons may be provided around the screen. In an exemplary embodiment, functions of each push button from the plurality of push buttons may be determined by some words printed next to the each push button.

In an alternative embodiment, the user interface and control section may be electromechanical. In this embodiment, water temperature may be controlled by utilizing an adjustable bimetal or thermostat which may implement a closed-loop control by using mechanical feedbacks which may be sensed by its probe. In an exemplary embodiment, the probe may be installed inside or outside of the boiler reservoir. In an exemplary embodiment, a user may be able to adjust water temperature by using a rotary switch or a linear switch installed on the user interface section. In an exemplary embodiment, a user may be able to determine the number of brew cups by using a selector which may be a rotary selector or a linear selector.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1A illustrates a perspective view of an exemplary combined hot water dispenser and beverage brewer with a fully electronic user interface and control section, consistent with one or more exemplary embodiments of the present disclosure.

FIG. 1B illustrates a perspective view of a combined hot water dispenser and beverage brewer with an electromechanical user interface and control section, consistent with one or more exemplary embodiments of the present disclosure.

FIG. 1C illustrates an exploded view of a combined hot water dispenser and beverage brewer with a detachable water storage section, consistent with one or more exemplary embodiments of the present disclosure.

FIG. 1D illustrates a back view of a combined hot water dispenser and beverage brewer with an electric plug, consistent with one or more exemplary embodiments of the present disclosure.

FIG. 2A illustrates a schematic view of a combined hot water dispenser and beverage brewer, consistent with one or more exemplary embodiments of the present disclosure.

FIG. 2B illustrates a schematic view of combined hot water dispenser and beverage brewer, consistent with one or more exemplary embodiments of the present disclosure.

FIG. 3A illustrates a schematic view of a combined hot water dispenser and beverage brewer, consistent with one or more exemplary embodiments of the present disclosure.

FIG. 3B illustrates an exploded view of a water storage section, consistent with one or more exemplary embodiments of the present disclosure.

FIG. 3C illustrates a detailed view of a first connecting mechanism in an attached situation, consistent with one or more exemplary embodiments of the present disclosure.

FIG. 3D illustrates an exploded view of a first connecting mechanism in a detached situation, consistent with one or more exemplary embodiments of the present disclosure.

FIG. 3E illustrates a detailed view of a first connecting mechanism in an attached situation, consistent with one or more exemplary embodiments of the present disclosure.

FIG. 3F illustrates a detailed view of a first connecting mechanism in an attached situation, consistent with one or more exemplary embodiments of the present disclosure.

FIG. 3G illustrates a detailed view of a first connecting mechanism in an attached situation, consistent with one or more exemplary embodiments of the present disclosure.

FIG. 3H illustrates a detailed view of a first connecting mechanism in an attached situation, consistent with one or more exemplary embodiments of the present disclosure.

FIG. 3I illustrates a detailed view of a first connecting mechanism in an attached situation, consistent with one or more exemplary embodiments of the present disclosure.

FIG. 3J illustrates an exploded view of a second connecting mechanism in a detached situation, consistent with one or more exemplary embodiments of the present disclosure.

FIG. 4A illustrates a side view of a pinch valve mechanism in a first scenario in which the pinch valve mechanism is closed, consistent with one or more exemplary embodiments of the present disclosure.

FIG. 4B illustrates a section side view of a pinch valve mechanism in a first scenario in which the pinch valve mechanism is closed, consistent with one or more exemplary embodiments of the present disclosure.

FIG. 4C illustrates a side view of a pinch valve mechanism in a second scenario in which the pinch valve mechanism is open, consistent with one or more exemplary embodiments of the present disclosure.

FIG. 4D illustrates a section side view of a pinch valve mechanism in a second scenario in which the pinch valve mechanism is open, consistent with one or more exemplary embodiments of the present disclosure.

FIG. 4E illustrates a perspective view of a pinch valve mechanism, consistent with one or more exemplary embodiments of the present disclosure.

FIG. 5A illustrates a front view of a user interface of an exemplary combined hot water dispenser and beverage brewer with a fully electronic user interface and control section, consistent with one or more exemplary embodiments of the present disclosure.

FIG. 5B illustrates a front view of a user interface of a combined hot water dispenser and beverage brewer with an electromechanical user interface and control section, consistent with one or more exemplary embodiments of the present disclosure.

FIG. 6 shows an example computer system, consistent with one or more exemplary embodiment of the present disclosure.

### DESCRIPTION OF EMBODIMENTS

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

The following detailed description is presented to enable a person skilled in the art to make and use the methods and devices disclosed in exemplary embodiments of the present disclosure. For purposes of explanation, specific nomenclature is set forth to provide a thorough understanding of the present disclosure. However, it will be apparent to one skilled in the art that these specific details are not required to practice the disclosed exemplary embodiments. Descriptions of specific exemplary embodiments are provided only as representative examples. Various modifications to the exemplary implementations will be readily apparent to one skilled in the art, and the general principles defined herein may be applied to other implementations and applications without departing from the scope of the present disclosure. The present disclosure is not intended to be limited to the implementations shown, but is to be accorded the widest possible scope consistent with the principles and features disclosed herein.

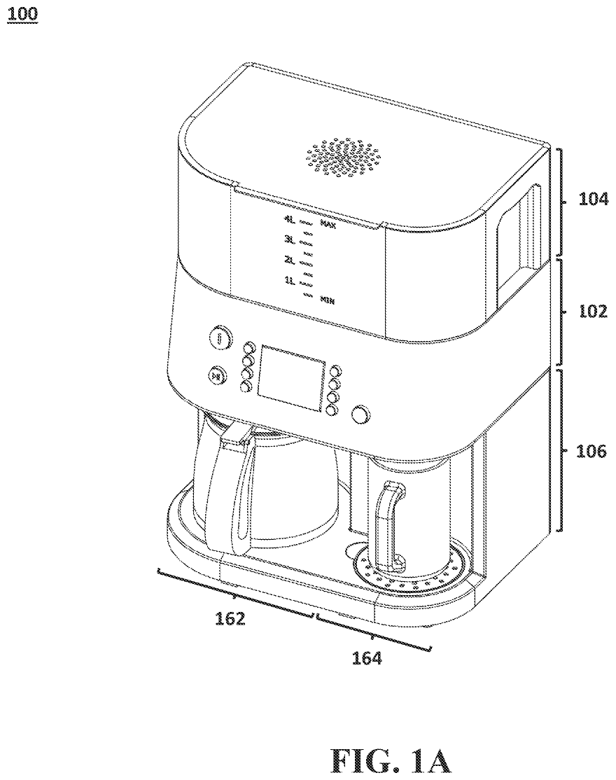

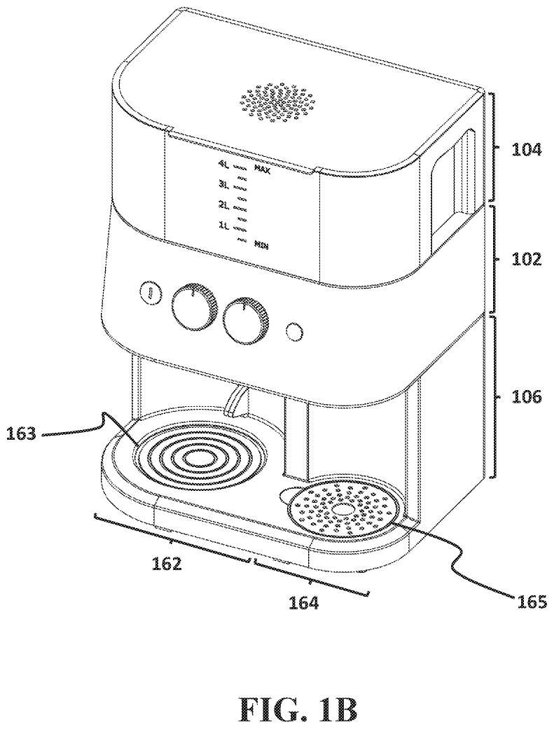

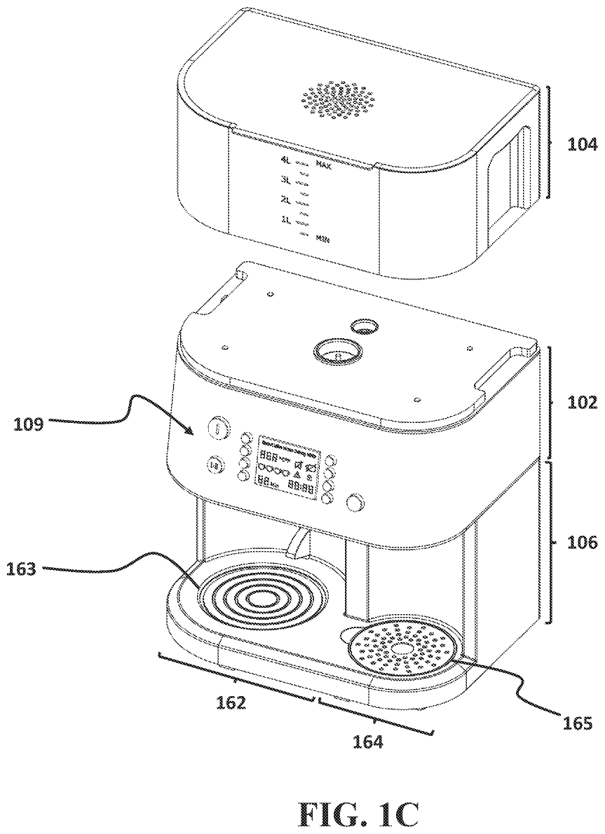

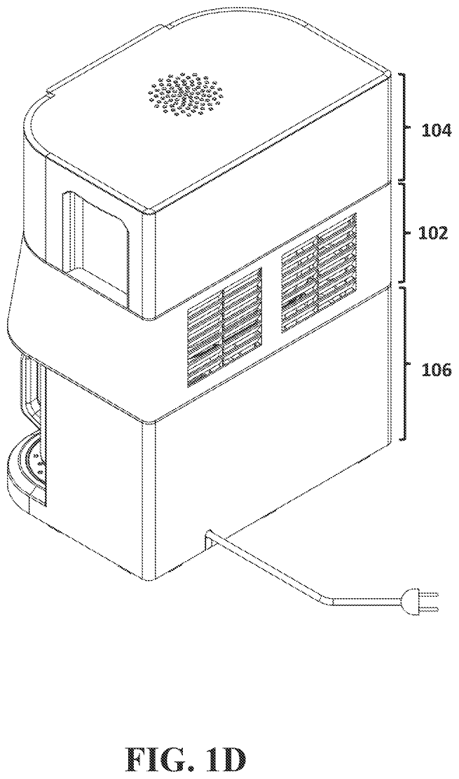

Disclosed herein is a combined hot water dispenser and beverage brewer. An exemplary combined hot water dispenser and beverage brewer may be used for both brewing a beverage and providing hot water. FIG. 1A shows a perspective view of an exemplary combined hot water dispenser and beverage brewer 100 with a fully electronic user interface and control section, consistent with one or more exemplary embodiments of the present disclosure. FIG. 1B shows a perspective view of combined hot water dispenser and beverage brewer 100 with an electromechanical user interface and control section, consistent with one or more exemplary embodiments of the present disclosure. FIG. 1C shows an exploded view of combined hot water dispenser and beverage brewer 100, consistent with one or more exemplary embodiments of the present disclosure. FIG. 1D shows a back view of combined hot water dispenser and beverage brewer 100 with an electric plug, consistent with one or more exemplary embodiments of the present disclosure. As shown in FIG. 1A, FIG. 1B, FIG. 1C, and FIG. 1D, in an exemplary embodiment, combined hot water dispenser and beverage brewer 100 may include a water heating section 102, a water storage section 104, a delivery section 106, and a user interface combined with a control section 109.

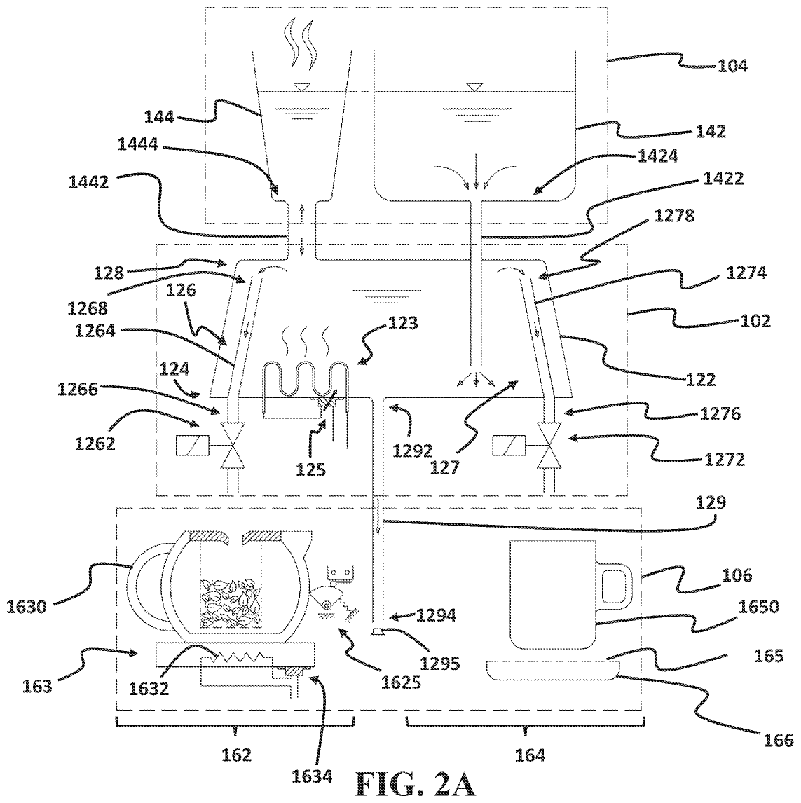

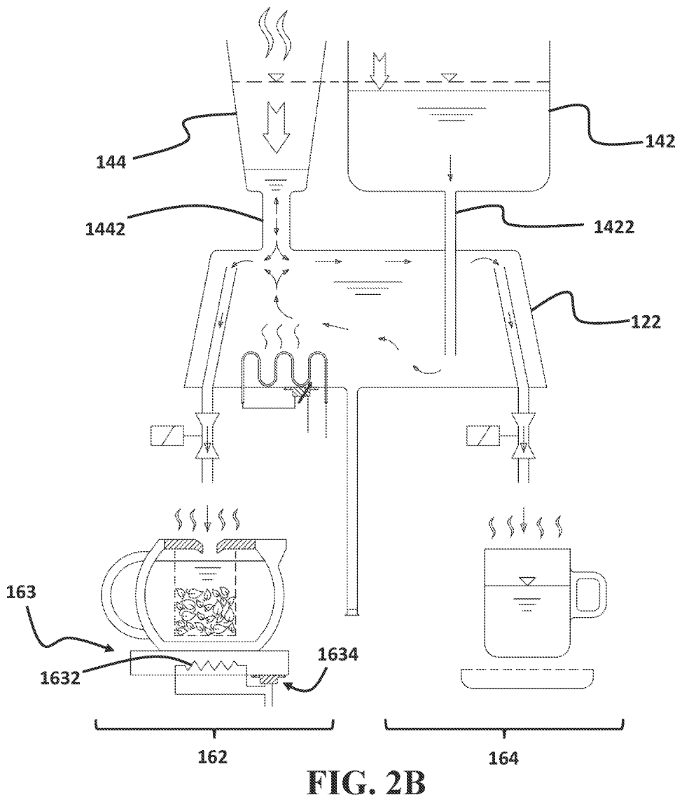

FIG. 2A shows a schematic view of combined hot water dispenser and beverage brewer 100, consistent with one or more exemplary embodiments of the present disclosure. As shown in FIG. 2A, in an exemplary embodiment, water heating section 102 may include a boiler reservoir 122. In an exemplary embodiment, boiler reservoir 122 may be configured to receive and store water. In an exemplary embodiment, water heating section 102 may further include a heating element 123. In an exemplary embodiment, heating element 123 may be configured to heat water inside boiler reservoir 122. In an exemplary embodiment, the heating element may refer to an element that converts electrical energy into heat through the process of Joule heating. Electrical current through the element encounters resistance, resulting in heating of the element. In an exemplary embodiment, heating element 123 may be disposed inside boiler reservoir 122 and at a bottom end 124 of boiler reservoir 122. In an exemplary embodiment, when heating element 123 heats up, due to the fact that heating element 123 is in contact with water inside boiler reservoir 122, water inside boiler reservoir 122 may also heat up. In an exemplary embodiment, heating element 123 may comprise one of a tubular electric heater, a folded tubular heating element, a coiled heating element, a thick film heater, a polymer PCT heating element, a composite heating element, or a combination thereof. However, in an exemplary embodiment, heating element 123 may be disposed at any other place inside boiler reservoir 122. In an exemplary embodiment, heating element 123 may be disposed outside boiler reservoir 122 in such a way that heating element 123 is able to heat the water inside boiler reservoir 122.

As further shown in FIG. 2A, in an exemplary embodiment, water heating section 102 may further include an adjustable thermostat 125 in connection with heating element 123. In an exemplary embodiment, adjustable thermostat may refer to a thermostat that is able to be adjusted by a user. In an exemplary embodiment, adjustable thermostat 125 may be configured to turn off heating element 123 when a temperature of heating element 123 or the water inside boiler reservoir 122 is more than a predetermined threshold. In an exemplary embodiment, an adjustable thermostat may include a thermometer and a controller. In an exemplary embodiment, a user may set a temperature for the adjustable thermostat. In an exemplary embodiment, the thermometer may constantly measure the temperature of the water inside boiler reservoir 122. Whenever, the temperature of the water reaches the set temperature, the controller may turn off the heating element to prevent overheating the water inside boiler reservoir 122. In an exemplary embodiment, it may be understood that using adjustable thermostat 125 may help preventing overheat in heating element 123. In an exemplary embodiment, by utilizing adjustable thermostat 125, whenever boiler reservoir 122 is empty, heating element 123 may be turned off and, consequently, any damage to heating element 123 or boiler reservoir 122 may be prevented. Furthermore, in an exemplary embodiment, temperature of water inside boiler reservoir 122 may be controlled by utilizing adjustable thermostat 125. In an exemplary embodiment, adjustable thermostat 125 may be disposed outside boiler reservoir 122. However, in an exemplary embodiment, adjustable thermostat 125 may be disposed inside boiler reservoir 122.

In an exemplary embodiment, heating section 102 may further include a first water discharge mechanism 126. In an exemplary embodiment, first water discharge mechanism 126 may be configured to discharge water from boiler reservoir 122. In an exemplary embodiment, first water discharge mechanism 126 may include a first discharge faucet 1262 that may be disposed under boiler reservoir 122. In an exemplary embodiment, first water discharge mechanism 126 may further include a first discharge tube 1264. In an exemplary embodiment, a bottom end 1266 of first discharge tube 1264 may be connected to first discharge faucet 1262. For purpose of reference, it may be understood that when first discharge faucet 1262 is turned on, the gravity force may urge the water inside first discharge tube 1264 to discharge from bottom end 1266 of first discharge tube 1264. In an exemplary embodiment, first discharge faucet 1262 being turned off may refer to a state that first discharge faucet 1262 blocks bottom end 1266 of first discharge tube 1264 and, consequently, water is not able to be discharged from bottom end 1266 of first discharge tube 1264. In an exemplary embodiment, first discharge faucet 1262 being turned on may refer to a state that first discharge faucet 1262 does not block bottom end 1266 of first discharge tube 1264 and, consequently, water is able to be discharged from bottom end 1266 of first discharge tube 1264. In an exemplary embodiment, a top end 1268 of first discharge tube 1264 may be disposed at a top end 128 of boiler reservoir 122. In an exemplary embodiment, it may be understood that when first discharge faucet 1262 is turned on, the water may be discharged from top end 128 of boiler reservoir 122 and through first discharge tube 1264.

In an exemplary embodiment, heating section 102 may further include a second water discharge mechanism 127. In an exemplary embodiment, second water discharge mechanism 127 may be configured to discharge water from boiler reservoir 122. In an exemplary embodiment, second water discharge mechanism 127 may include a second discharge faucet 1272 that may be disposed under boiler reservoir 122. In an exemplary embodiment, second water discharge mechanism 127 may further include a second discharge tube 1274. In an exemplary embodiment, a bottom end 1276 of second discharge tube 1274 may be connected to second discharge faucet 1272. In an exemplary embodiment, it may be understood that when second discharge faucet 1272 is turned on, the gravity force may urge the water inside second discharge tube 1274 to discharge from bottom end 1276 of second discharge tube 1274. In an exemplary embodiment, second discharge faucet 1272 being turned off may refer to a state that second discharge faucet 1272 blocks bottom end 1276 of second discharge tube 1274 and, consequently, water is not able to be discharged from bottom end 1276 of second discharge tube 1274. In an exemplary embodiment, second discharge faucet 1272 being turned on may refer to a state that second discharge faucet 1272 does not block bottom end 1276 of second discharge tube 1274 and, consequently, water is able to be discharged from bottom end 1276 of second discharge tube 1274. In an exemplary embodiment, a top end 1278 of second discharge tube 1274 may be disposed at a top end 128 of boiler reservoir 122. In an exemplary embodiment, it may be understood that when second discharge faucet 1272 is turned on, the water may be discharged from top end 128 of boiler reservoir 122 and through second discharge tube 1274.

In an exemplary embodiment, first water discharge mechanism 126 and second water discharge mechanism 127 may be disposed at opposite lateral sides of boiler reservoir 122. For example, first water discharge mechanism 126 may be disposed at a left side of boiler reservoir 122 and second water discharge mechanism may be disposed at a right side of boiler reservoir 122. However, in different embodiments, first water discharge mechanism 126 and second water discharge mechanism 127 may be disposed at different places inside boiler reservoir 122.

In an exemplary embodiment, water storage section 104 may include a cold water reservoir 142 and a hot water reservoir 144. In an exemplary embodiment, cold water reservoir 142 may be a reservoir that is configured to receive and store water. In an exemplary embodiment, cold water reservoir 142 may be disposed above boiler reservoir 122. In an exemplary embodiment, cold water reservoir may be in fluid communication with bottom end 124 of boiler reservoir 122 through a cold water tube 1422.

In an exemplary embodiment, hot water reservoir 144 may be a reservoir that is configured to receive and store water. In an exemplary embodiment, hot water reservoir 144 may be in fluid communication with top end 128 of boiler reservoir 122 through a hot water inlet 1442. In an exemplary embodiment, hot water reservoir 144 may be disposed above boiler reservoir 122. Due to the fact that hotter water and vapor bubbles inside boiler reservoir 122 may flow toward top end 128 of boiler reservoir 122, it may be understood that when hot water reservoir 144 is in fluid communication with top end 128 of boiler reservoir 122, hot water and vapor bubbles may go from boiler reservoir 122 into hot water reservoir 144. In an exemplary embodiment, it may be understood that vapor bubbles may be released into open air above hot water reservoir 144 from hot water reservoir 144.

In an exemplary embodiment, after that an amount of water is heated by heating element 123, the heated amount of water may flow toward top end 128 of boiler reservoir 122 and then the heated amount of water may flow into hot water reservoir 144 through hot water inlet 1442. In an exemplary embodiment, an inner diameter of hot water inlet 1442 may be larger than an inner diameter of cold water tube 1422. Also, in an exemplary embodiment, a length of cold water tube 1422 may be longer than a length of hot water inlet 1442. For purpose of reference, it may be understood that when the inner diameter of hot water inlet 1442 is larger than the inner diameter of cold water tube 1422 and the length of cold water tube 1422 is longer than the length of hot water inlet 1442, the heated water may flow into hot water reservoir 144 rather than cold water reservoir 142 due to lower head loss in hot water inlet 1442 in comparison with cold water tube 1422. In an exemplary embodiment, it may provide significant benefits. For example, when little or no heated water is allowed to return to cold water reservoir 142, the heated water may not be mixed with cold water and, consequently, less energy may be needed to heat up the water inside boiler reservoir 122.

As further shown in FIG. 2A, in an exemplary embodiment, combined hot water dispenser and beverage brewer 100 may further include a delivery section 106. In an exemplary embodiment, delivery section 106 may include a beverage brewing section 162 and a hot water delivery section 164. In an exemplary embodiment, beverage brewing section 162 may be associated with first water discharge mechanism 126. In an exemplary embodiment, first water discharge mechanism 126 may provide water for beverage brewing section 162. In an exemplary embodiment, beverage brewing section 162 may be disposed under first discharge faucet 1262. In an exemplary embodiment, beverage brewing section 162 may include a beverage heating mechanism 163. In an exemplary embodiment, beverage heating mechanism 163 may be configured to receive a beverage container 1630. In an exemplary embodiment, beverage heating mechanism 163 may include a plate. In an exemplary embodiment, a user may place a beverage container onto the plate so that the plate holds the beverage container. In an exemplary embodiment, when beverage heating mechanism 163 receives beverage container 1630, it may mean that a user puts beverage container 1630 onto the beverage heating mechanism. In an exemplary embodiment, beverage container 1630 may include a teapot, a pot, a dish, or any other type of container which may be able to accommodate tea leaves, coffee grains, or other types of hot beverage ingredients. In an exemplary embodiment, beverage heating mechanism 163 may further be configured to secure beverage container 1630 under first discharge faucet 1262. In an exemplary embodiment, heating mechanism 163 may further be configured to heat beverage container 1630. In an exemplary embodiment, heating mechanism 163 may include a heater 1632 that is configured to heat beverage container 1630. In an exemplary embodiment, heating mechanism 163 may further include a thermostat 1634 that may be configured to control the temperature of the heater 1632 through turning on and/or turning off heater 1632. In an exemplary embodiment, thermostat 1634 may be similar to adjustable thermostat 125 in structure and functionality. In an exemplary embodiment, thermostat 1634 may include a thermometer and a controller. In an exemplary embodiment, a user may set a temperature for the thermostat 1634. In an exemplary embodiment, the thermometer may constantly measure the temperature of heater 1632. Whenever, the temperature of heater 1632 reaches the set temperature, the controller may turn off the heating element to prevent overheating heater 1632. In an exemplary embodiment, when first discharge faucet 1262 is turned on, water may be discharged from top end 128 of boiler reservoir 122 and through first discharge tube 1264 into beverage container 1630. In an exemplary embodiment, the water discharged from top end 128 of boiler reservoir 122 and through first discharge tube 1264 into beverage container 1630 may be used to brew tea or coffee in beverage container 1630.

In an exemplary embodiment, beverage brewing section 162 may further include a second micro switch mechanism 1625. In an exemplary embodiment, second micro switch mechanism 1625 may be configured to detect presence of beverage container 1630 on beverage heating mechanism 163. In an exemplary embodiment, second micro switch mechanism 1625 may include a limit switch. In an exemplary embodiment, the limit switch may consist of an actuator mechanically linked to an electrical switch. In an exemplary embodiment, when an object such as beverage container 1630 contacts the actuator, the electrical switch may operate causing an electrical connection make or break which may help detecting presence of beverage container 1630. In an exemplary embodiment, second micro switch mechanism 1625 may be in connection with first discharge faucet 1262. In an exemplary embodiment, when beverage container 1630 is not present on heating mechanism 163, first discharge faucet 1262 may be prevented to be turned on.

In an exemplary embodiment, hot water delivery section 164 may be associated with second water discharge mechanism 127. In an exemplary embodiment, hot water delivery section 164 may be disposed under second discharge faucet 1272. In an exemplary embodiment, hot water delivery section 164 may include a water container holding member 165. In an exemplary embodiment, water container holding member 165 may be configured to receive a water container 1650. In an exemplary embodiment, water container holding member 165 may be a bowl-shaped member that include a compartment. In an exemplary embodiment, a user may put water container 1650 into the compartment of water container holding member 165. In an exemplary embodiment, when water container holding member 165 receives water container 1650, it may mean that a user puts water container 1650 into water container holding member. In an exemplary embodiment, water container 1650 may include a glass, a pot, or any other type of container. In an exemplary embodiment, water container holding member 165 may be configured to secure water container 1650 under second discharge faucet 1272. In an exemplary embodiment, hot water delivery section 164 may further include a drain storage pot 166. In an exemplary embodiment, drain storage pot 166 may be disposed under water container holding member 165. In an exemplary embodiment, drain storage pot 166 may be configured to temporarily store a second amount of waste water. In an exemplary embodiment, it may be understood that the second amount of waste water may be poured into the water container holding member 165 by the user or when the water is overfilled in the water container 1650. In an exemplary embodiment, when second discharge faucet 1272 is turned on, water may be discharged from top end 128 of boiler reservoir 122 and through second discharge tube 1274 into water container 1650. In an exemplary embodiment, second discharge faucet 1272 being turned off may refer to a state that second discharge faucet 1272 blocks bottom end 1276 of second discharge tube 1274 and, consequently, water is not able to be discharged from bottom end 1276 of second discharge tube 1274. In an exemplary embodiment, second discharge faucet 1272 being turned on may refer to a state that second discharge faucet 1272 does not block bottom end 1276 of second discharge tube 1274 and, consequently, water is able to be discharged from bottom end 1276 of second discharge tube 1274.

In an exemplary embodiment, heating section 102 may further include a sewage pipe 129. In an exemplary embodiment, a top end 1292 of sewage pipe 129 may be connected to bottom end 124 of boiler reservoir 122 and a bottom end 1294 of sewage pipe 129 may be in communication with a sewage system through an external sewage valve. In an exemplary embodiment, bottom end 1294 of sewage pipe 129 may be closed by utilizing a cap 1295. In an exemplary embodiment, sewage pipe 129 and cap 1295 may provide benefits. For example, by removing cap 1295 from bottom end 1294 of sewage pipe 129, remained water in boiler reservoir 122 may be discharged through sewage pipe 129. Hence, when it is needed, a user may be able to discharge water remained in boiler reservoir 122 for a long time and replace it with fresh water.

FIG. 2B shows a schematic view of combined hot water dispenser and beverage brewer 100, consistent with one or more exemplary embodiments of the present disclosure. As shown in FIG. 2B, in an exemplary embodiment, a user may be able to pour water into cold water reservoir 142 from a top end of cold water reservoir 142. In an exemplary embodiment, when water is poured into boiler reservoir 122 through cold water tube 1422, water level in boiler reservoir 122 may go up until boiler reservoir 122 is filled with water, then water may go into hot water reservoir 144. In an exemplary embodiment, when water goes down inside cold water tube 1422, the water may become warmer due to heat transfer between the water and warmer water inside boiler reservoir 122 and surrounding cold water tube 1422. For purpose of reference, it may be understood that water may be preheated before entering boiler reservoir 122. Also, when water enters boiler reservoir 122 from cold water tube 1422, it may flow toward hot water reservoir 144. In an exemplary embodiment, when water flows from a bottom end of cold water tube 1422 toward hot water reservoir 144, the water may pass through a place near heating element 123 so water may be immediately heated after entering boiler reservoir 122.

In an exemplary embodiment, it may be understood that hot water may rise to top end 128 of boiler reservoir 122. In an exemplary embodiment, it may be noted that the molecules in warmer water are more spread than the molecules in cooler water which make the warmer water less dense. As the hot water is less dense, the hot water may rise to top end 128 of boiler reservoir 122. In an exemplary embodiment, when an amount of water is heated by heating element 123, the heated water may flow toward hot water reservoir 144. For purpose of reference, it may be understood that, the heated water may flow toward hot water reservoir 144 rather than flowing toward cold water reservoir 142 due to the fact that the inner diameter of hot water inlet 1442 is larger than the inner diameter of cold water tube 1422 and also the length of cold water tube 1422 is longer than the length of hot water inlet 1442 and, consequently, the head loss in cold water tube 1422 may be greater than the head loss in hot water inlet 1442.

In an exemplary embodiment, when one of first discharge faucet 1262 and second discharge faucet 1272 is turned on, water may flow from top end 128 of boiler reservoir 122 into the respective discharge tube from first discharge tube 1264 and second discharge tube 1274 and the majority of discharged water may be replaced with an amount of hot water in hot water reservoir 144. In an exemplary embodiment, it may be understood that hot reservoir 144 may be able to supply the majority of the consumed hot water because of the fact that cold water tube 1422 has a longer length and a smaller diameter. In an exemplary embodiment, it may be understood that due to the longer length and the smaller diameter of cold water tube 1422, cold water tube 1422 may have a greater head loss compared to hot water inlet 1442. Hence, it may be understood that water may go from hot water reservoir 144 into boiler reservoir 122 and may not go from cold water reservoir 142 into boiler reservoir 122

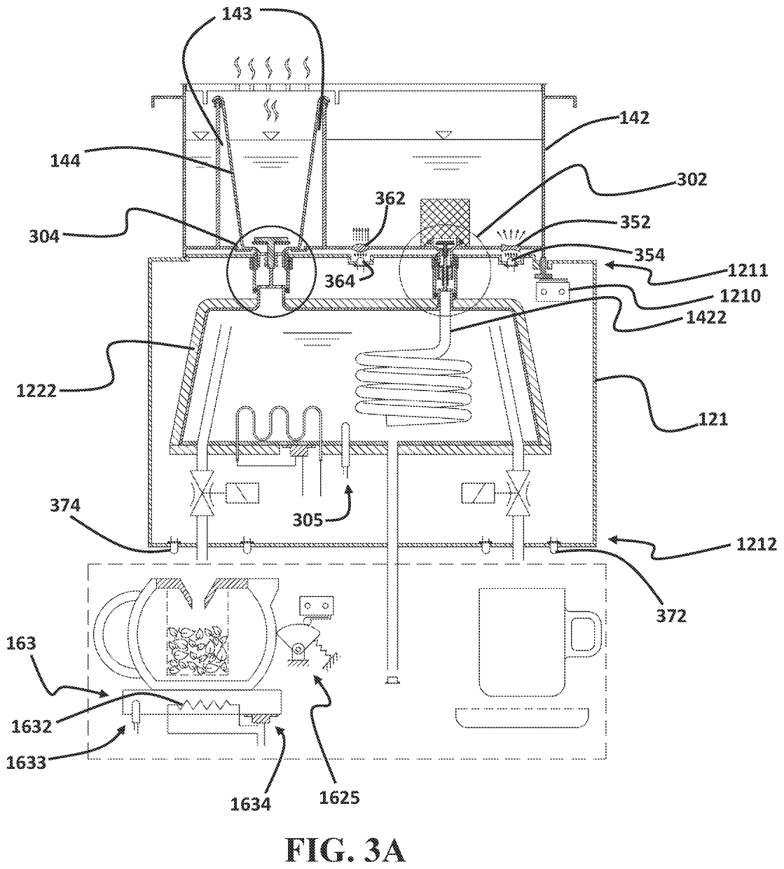

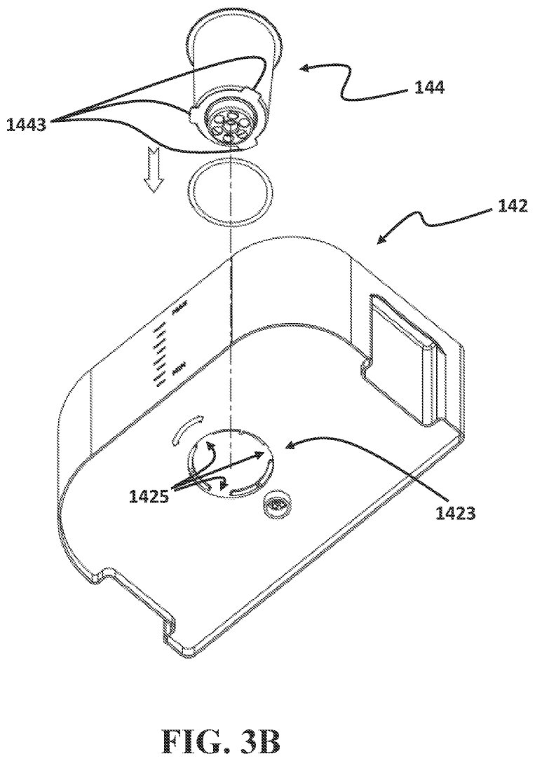

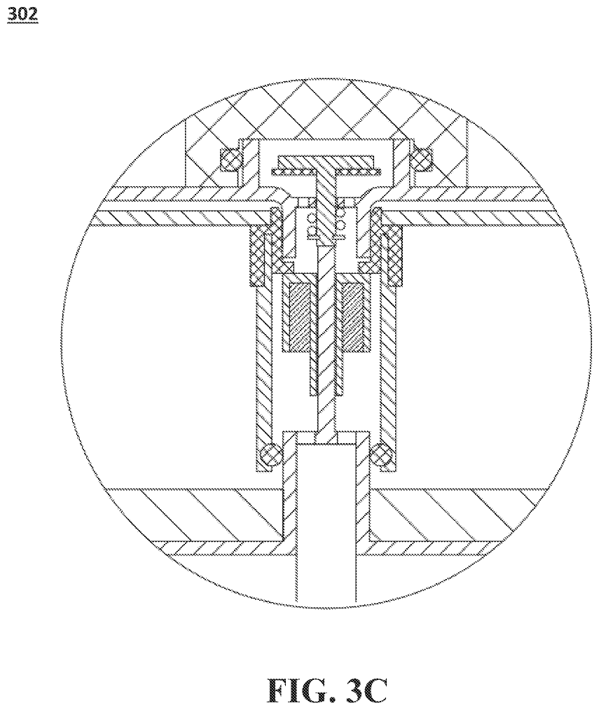

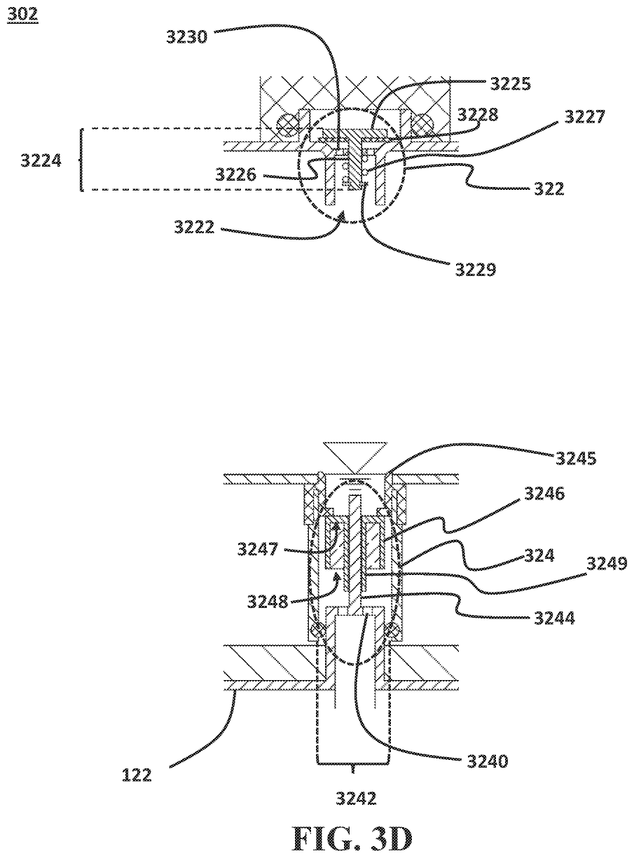

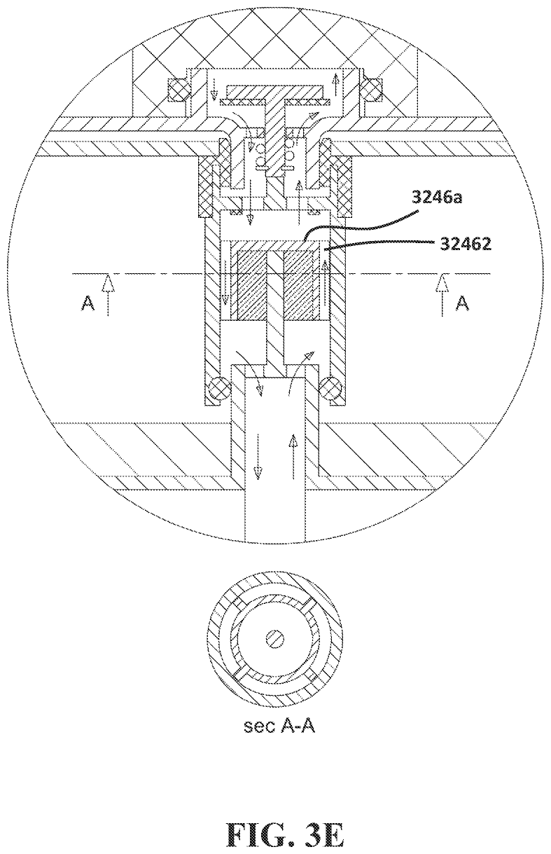

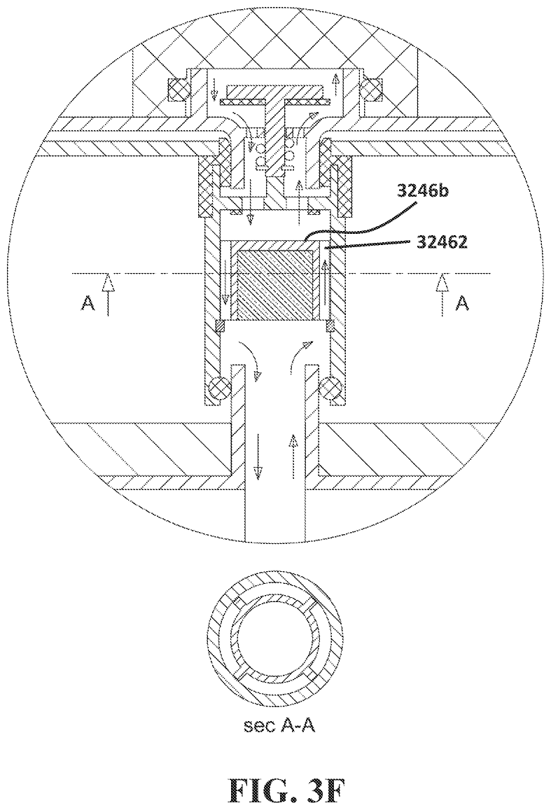

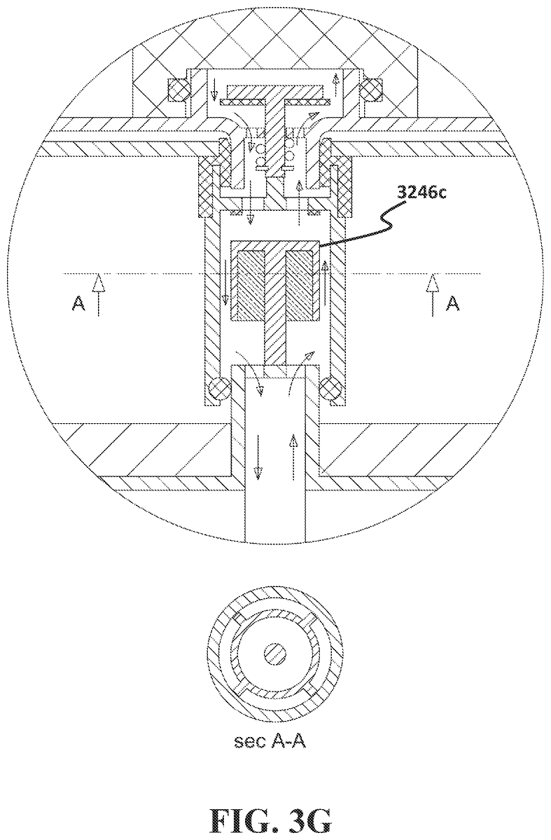

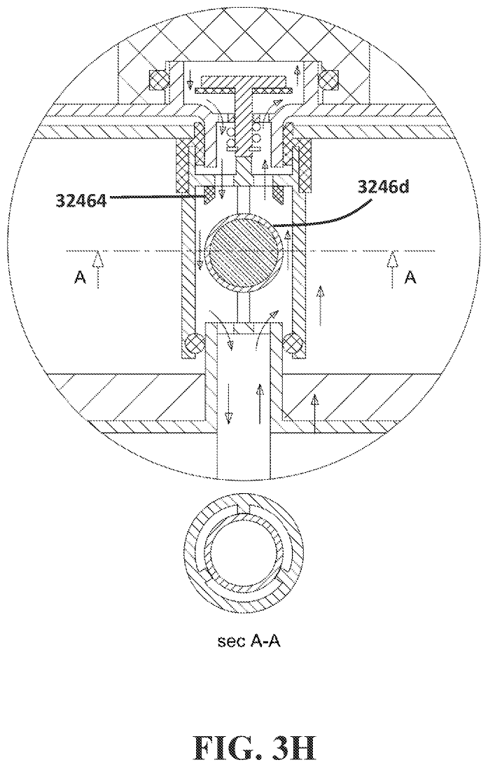

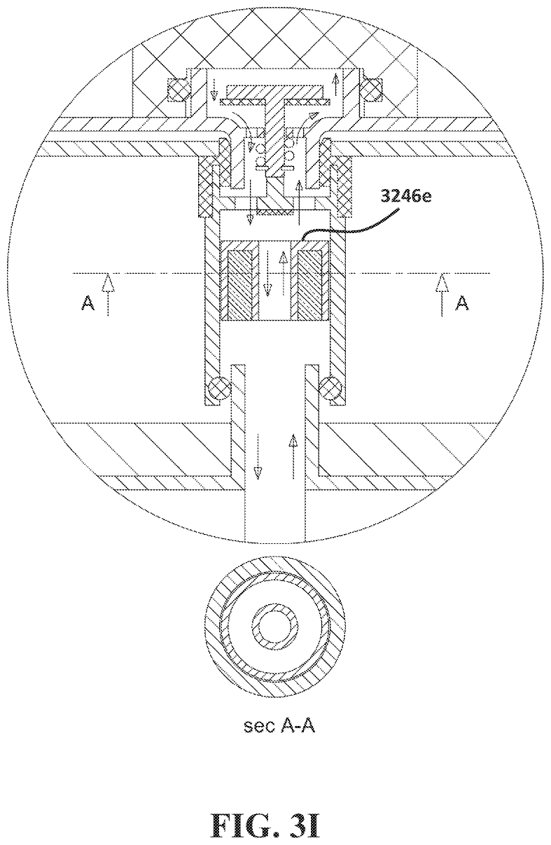

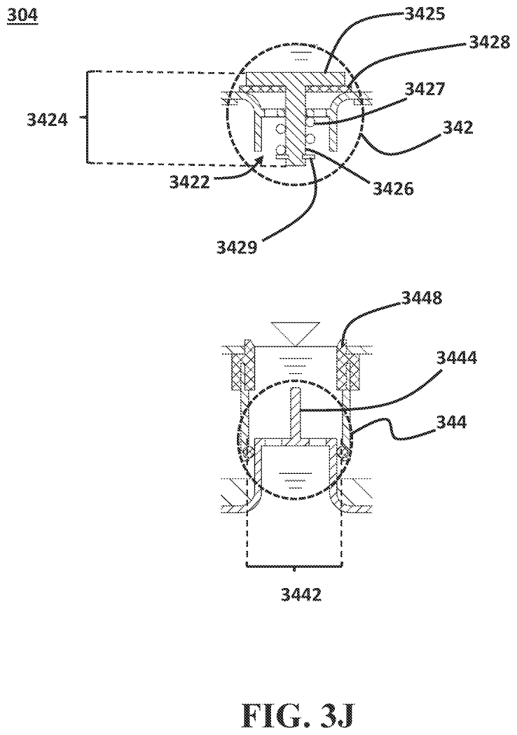

FIG. 3A shows a schematic view of combined hot water dispenser and beverage brewer 100, consistent with one or more exemplary embodiments of the present disclosure. As shown in FIG. 3A, in an exemplary embodiment, hot water reservoir 144 may be disposed inside cold water reservoir 142. In an exemplary embodiment, hot water reservoir 144 and cold water reservoir 142 may be separated with an insulating layer 143 to minimize heat transfer between hot water reservoir 144 and cold water reservoir 142. In an exemplary embodiment, insulating layer 143 may include an air gap. However, in different implementations, hot water reservoir 144 and cold water reservoir 142 may be separated by utilizing any other types of insulating mechanisms.

FIG. 3B shows an exploded view of water storage section 104, consistent with one or more exemplary embodiments of the present disclosure. As shown in FIG. 3B, in an exemplary embodiment, hot water reservoir 144 may be configured to be mounted onto cold water reservoir 142. In an exemplary embodiment, hot water reservoir 144 may be a receptacle that may be used to hold fluid and also may be used as a water supply. In an exemplary embodiment, hot water reservoir 144 may also be configured to be locked inside cold water reservoir 142 after that hot water reservoir 144 is mounted onto cold water reservoir 142. In an exemplary embodiment, hot water reservoir 144 may also be configured to be locked inside cold water reservoir 142 by utilizing a fastener mechanism. In an exemplary embodiment, the fastener mechanism may include a plurality of keys 1443 provided on a bottom end of hot water reservoir 144. In an exemplary embodiment, the fastener mechanism may further include a plurality of keyways 1425 provided on a bottom end of the cold water reservoir 144. In an exemplary embodiment, cold water reservoir 142 may include a hot water reservoir receiving hole 1423 at the bottom end of cold water reservoir 142. In an exemplary embodiment, water reservoir receiving hole 1423 may be configured to receive hot water reservoir 144. In an exemplary embodiment, the plurality of keyways may be arranged around hot water reservoir receiving hole 1423. In an exemplary embodiment, the plurality of keyways may be associated with the plurality of keys. In an exemplary embodiment, each respective key from the plurality of keys may be configured to pass through a respective keyway from the plurality of keyways. In an exemplary embodiment, hot water reservoir 144 may be inserted into hot water reservoir receiving hole 1423 and then hot water reservoir 144 may be rotated in a clockwise or counterclockwise direction so as to hot water reservoir 144 be connected and locked into cold water reservoir 142.

In an exemplary embodiment, water heating section 102 may include a first frame 121. In an exemplary embodiment, first frame 121 may include an insulating material to prevent or otherwise minimize heat transfer between boiler reservoir 122 and the surroundings. In an exemplary embodiment, boiler reservoir 122 may also include an insulation layer 1222 on an outer surface of boiler reservoir 122. In an exemplary embodiment, the insulation layer may be configured to prevent or otherwise minimize heat transfer between an inner side of boiler reservoir 122 and an outer side of boiler reservoir 122. In an exemplary embodiment, the insulation layer may be made form a material with a low heat transfer coefficient such as polyurethane foam. In an exemplary embodiment, water heating section 102 may include a first micro switch 1210 provided on first frame 121. In an exemplary embodiment, first micro switch 1210 may be configured to detect presence of cold water reservoir 142 mounted onto water heating section 102. In an exemplary embodiment, first micro switch 1210 may include a limit switch. In an exemplary embodiment, an exemplary limit switch may consist of an actuator mechanically linked to an electrical switch. In an exemplary embodiment, when an object such as cold water reservoir 142 contacts the actuator, the electrical switch may operate causing an electrical connection make or break which may help detecting presence of the object.

In an exemplary embodiment, a first lens 352 and a second lens 362 may be provided at bottom end 1424 of cold water reservoir 142. In an exemplary embodiment, cold water reservoir 142 may be made of a transparent material and first lens 352 and second lens 362 may be provided at the bottom of cold water reservoir 142 through applying thickness change in the bottom of cold water reservoir 142. Also, a first light source 354 and a second light source 364 may be provided at a top end 1211 of first frame 121. In an exemplary embodiment, first lens 352 may include a divergent lens. In an exemplary embodiment, second lens 362 may include a convergent lens. In an exemplary embodiment, first lens 352, second lens 362, first light source 354, and second light source 364 together may be utilized for lighting purposes which may provide a better sight for a user. In an exemplary embodiment, a plurality of multi-color light sources may be used in combined hot water dispenser and beverage brewer 100. In an exemplary embodiment, the color of the lights may be used as different notifications for a user. For example, red color may be used as a notification to indicate that combined hot water dispenser and beverage brewer 100 is switched on and green color may be used as a notification to indicate that water temperature is reached to a predetermined set point. Another color may be used as a notification to indicate that the beverage brewing process is finished. In an exemplary embodiment, it may be understood that multi-color light sources may help deaf and/or illiterate people to utilize combined hot water dispenser and beverage brewer 100 more easily. In an exemplary embodiment, a first temperature sensor 305 may be used to send a first temperature feedback to a controller. In an exemplary embodiment, the first temperature feedback may be associated with the water temperature inside boiler reservoir 122. In an exemplary embodiment, the controller may be configured to switch on and/or switch off heating element 123 based on the first temperature feedback to achieve a precise water temperature in boiler reservoir 122 on a closed-loop basis. In an exemplary embodiment, the controller may send signals and/or commands to heating element 123 to switch on and/or switch off heating element 123 based on the first temperature feedback. In an exemplary embodiment, a closed-loop system may refer to a system with the ability to self-correct.

In an exemplary embodiment, delivery section 106 may further include a third light source 372 and a fourth light source 374 provided at a bottom end 1212 of first frame 121. In an exemplary embodiment, third light source 372 may provide lighting for hot water delivery section 164. In an exemplary embodiment, fourth light source 374 may provide lighting for beverage brewing section 162. In an exemplary embodiment, beverage heating mechanism 163 may include a second temperature sensor 1633. In an exemplary embodiment, second temperature sensor 1633 may be configured to send a second temperature feedback to the controller. In an exemplary embodiment, the second temperature feedback may be associated with beverage heating mechanism 163. In an exemplary embodiment, the second temperature feedback may contain a data that may determine temperature of beverage heating mechanism 163. In an exemplary embodiment, the controller may be configured to switch on and/or switch off heating element 1632 based on the second temperature feedback so as to achieve a precise beverage temperature. In an exemplary embodiment, the controller may send signals and/or commands to heating element 1632 to switch on and/or switch off heating element 1632 based on the second temperature feedback. In an exemplary embodiment, this closed-loop temperature control may enable combined hot water dispenser and beverage brewer 100 to heat up and brew any beverage with their respective needed temperature. In an exemplary embodiment, a second thermostat may be used to protect heating element 1632.

As further shown in FIG. 3A, in an exemplary embodiment, cold water tube 1422 may include a helical or curved tube of any shape. In an exemplary embodiment, using a helical or curved tube for cold water tube 1422 may provide significant benefits. For example, due to the longer length of the helical tube, water may be exposed to more heat transfer with the water inside boiler reservoir 122 and, consequently, may enter boiler reservoir 122 with a higher temperature. Furthermore, the heated water in boiler reservoir 122 may be prevented to go up through cold water tube 1422 due to the higher head loss in cold water tube 1422 in comparison with head loss in hot water inlet 1442.

As further shown in FIG. 3A, in an exemplary embodiment, cold water reservoir 142 may be mounted detachably onto boiler reservoir 122 by utilizing a first connecting mechanism 302. FIG. 3C shows a detailed view of first connecting mechanism 302, consistent with one or more exemplary embodiments of the present disclosure. FIG. 3D shows an exploded view of first connecting mechanism 302, consistent with one or more exemplary embodiments of the present disclosure. As shown in FIG. 3C and FIG. 3D, in an exemplary embodiment, first connecting mechanism 302 may include a first poppet valve mechanism 322 provided at a bottom end 1424 of cold water reservoir 142. In an exemplary embodiment, first poppet valve mechanism 322 may include a first outlet hole 3222 provided at bottom end 1424 of cold water reservoir 142. In an exemplary embodiment, first poppet valve mechanism 322 may further include a first plunger 3224 disposed slidably inside first outlet hole 3222. In an exemplary embodiment, first plunger 3224 may include a first plunger disk 3225 at a top end of first plunger 3224, a first flexible gasket 3228 attached to first plunger disk 3225, and a first plunger rod 3226 at a bottom end of first plunger 3224. In an exemplary embodiment, first plunger rod 3226 may be guided by a hole located at bottom end 1424 of cold water reservoir 142 around which a plurality of openings 3230 may be provided which may allow water to pass through them when first plunger 3224 is moved upwardly. In an exemplary embodiment, first plunger disk 3225 may be configured to block first outlet hole 3222 by squeezing first flexible gasket 3228. In an exemplary embodiment, first plunger disk 3225 may apply a force to first flexible gasket 3228 and, to thereby, squeeze first flexible gasket 3228 which may cause blockage of first outlet hole 3222 as first flexible gasket 3228 may act as a sealing mechanism. In an exemplary embodiment, when first outlet hole 3222 is blocked, water discharge from cold water reservoir 142 and through first outlet hole 3222 may be prevented. In an exemplary embodiment, first plunger disk 3225 may further be configured to unblock first outlet hole 3222 when first plunger disk 3225 is moved upwardly inside first outlet hole 3222. In an exemplary embodiment, when first plunger disk 3225 is moved upwardly inside first outlet hole 3222, fluid communication may be provided between two sides of first outlet hole 3222. In an exemplary embodiment, when first outlet hole 3222 is unblocked, water may be discharged from cold water reservoir 142 and through first outlet hole 3222.

In an exemplary embodiment, first poppet valve mechanism 322 may further include a first retaining spring 3227 disposed between bottom end 1424 of cold water reservoir 142 and bottom end of first plunger 3224 using a retainer such as retaining ring 3229. In an exemplary embodiment, first retaining spring 3227 may be configured to urge first plunger 3224 to move downward. In an exemplary embodiment, first retaining spring 3227 may apply a force to first plunger 3224 which may urge first plunger 3224 to move downward. For purpose of reference, it may be understood that in absence of an external force, first retaining spring 3227 may urge first plunger 3224 to retain first plunger's 3224 initial position and, to thereby, block first outlet hole 3222.

In an exemplary embodiment, first connecting mechanism 302 may further include a buoyancy valve mechanism 324 provided at top end 128 of boiler reservoir 122. In an exemplary embodiment, buoyancy valve mechanism 324 may include a first inlet hole 3242 provided at a top end 128 of boiler reservoir 122. In an exemplary embodiment, first inlet hole 3242 may be associated with first outlet hole 3222. In an exemplary embodiment, a top end of cold water tube 1422 may be connected to first inlet hole 3242. In an exemplary embodiment, when cold water reservoir 142 is mounted onto boiler reservoir 122, first inlet hole 3242 and first outlet hole 3222 may be aligned and sealed with each other using a second flexible gasket 3245 and, to thereby, water may be discharged from cold water reservoir 142 into cold water tube 1422. In an exemplary embodiment, second flexible gasket 3245 may be located at an upper side of first inlet hole 3242. In an exemplary embodiment, buoyancy valve mechanism 324 may further include a first trigger rod 3244 attached to top end 128 of boiler reservoir 122. In an exemplary embodiment, first trigger rod 3244 may be associated with first plunger rod 3226. In an exemplary embodiment, when cold water reservoir 142 is mounted onto boiler reservoir 122, first trigger rod 3244 may push first plunger rod 3226 upwardly and, to thereby, may urge first plunger 3224 to overcome the spring force and move upwardly inside first outlet hole 3222. In an exemplary embodiment, it may be understood that when first plunger 3224 is moved upwardly inside first outlet hole 3222, first outlet hole 3222 may be unblocked and water may be discharged into boiler reservoir 122 from cold water reservoir 142. In an exemplary embodiment, top end 128 of boiler reservoir 122 may include a second plurality of openings 3240 surrounding first trigger rod 3244 which may be configured to allow water to pass through them and enter boiler reservoir 122. In an exemplary embodiment, second plurality of openings 3240 may include a plurality of holes that provide fluid communication between upper side of first inlet hole 3242 and lower side of first inlet hole 3242.

In an exemplary embodiment, first connecting mechanism 302 may provide significant benefits. For example, by utilizing first connecting mechanism 302, water may be discharged from bottom end 1424 of cold water reservoir 142 just when cold water reservoir 142 is mounted onto boiler reservoir 122. Accordingly, a user may be able to attach cold water reservoir 142 to boiler reservoir 122 and/or detach cold water reservoir 142 from boiler reservoir 122 easily with little or no water leakage from cold water reservoir 142. It may be understood that a user may be able to easily clean and/or disinfect cold water reservoir 122.

In an exemplary embodiment, first connecting mechanism 302 may further include a floating valve 3246 dispose slidably inside first inlet hole 3242. In an exemplary embodiment, floating valve 3246 may include a valve disk 3247 at a top end of floating valve 3246. As shown in FIG. 3D, in an exemplary embodiment, floating valve 3246 may include an empty cavity 3248 of any shape to store air which may decrease the overall density of floating valve 3246. This decrease may cause the floating valve 3246 to be able to float on water surface due to buoyancy principle. In an exemplary embodiment, floating valve 3246 may also include a guide bushing 3249 which may be guided by first trigger rod 3244, and consequently, may result in a smoother reciprocating movement for floating valve 3246 and may guarantee its vertical orientation and the presence of air inside empty cavity 3248.

In an exemplary embodiment, when boiler reservoir 122 and a lower side of first inlet hole 3242 are not filled with water and water flows downwardly inside first inlet hole 3242, floating valve 3246 may remain in its lowest position. In an exemplary embodiment, when floating valve 3246 is in its lowest position, water may be discharged from an upper side of first inlet hole 3242 to a lower side of first inlet hole 3242 from empty space around floating valve 3246. In an exemplary embodiment, when boiler reservoir 122 and first inlet hole 3242 are filled with water, floating valve 3246 may move upward. In an exemplary embodiment, when floating valve 3246 is moved upward, valve disk 3247 may block first inlet hole 3242. In an exemplary embodiment, when valve disk 3247 blocks first inlet hole 3242, water may not be discharged from the lower side of first inlet hole 3242 to the upper side of first inlet hole 3242. In an exemplary embodiment, floating valve 3246 may provide significant benefits. For example, by utilizing floating valve 3246, heated water may not be able to go up to cold water reservoir 142 through cold water tube 1422.

FIG. 3E, FIG. 3F, FIG. 3G, FIG. 3H, and FIG. 3I show detailed views of first connecting mechanism 302, consistent with one or more exemplary embodiments of the present disclosure. In an exemplary embodiment, floating valve 3246 may be replaced with a first floating valve 3246a, a second floating valve 3246b, a third floating valve 3246c, a fourth floating valve 3246d, and/or a fifth floating valve 3246e.

In an exemplary embodiment, floating valve 3246 may be replaced with first floating valve 3246a or second floating valve 3246b. In an exemplary embodiment, first floating valve 3246a or second floating valve 3246b may include a circular water passage way 32462 at an outer surface of them. As shown in FIG. 3E, FIG. 3F, and FIG. 3G, in this embodiment, first inlet hole 3242 may be configured to guide first floating valve 3246a, second floating valve 3246b, or third floating valve 3246c by utilizing a number of external ribs surrounding the floating valve. In an exemplary embodiment, an outer diameter of the floating valve with external ribs may correspond to an inner diameter of inlet hole 3242 so that the floating valve may be guided inside inlet hole 3242.

In an exemplary embodiment, floating valve 3246 may be replaced with fourth floating valve 3246d. In an exemplary embodiment, fourth floating valve 3246d may include a spherical member. In an exemplary embodiment, an inclined circular member 32464 may be used. In an exemplary embodiment, the spherical member may be configured to move upward and be attached to inclined circular member 32464 and, thereby, the spherical member and inclined circular member 32464 may block first inlet hole 3242. In an exemplary embodiment, a surface of inclined circular member 32464 may correspond to an external surface of the spherical member. Then, in an exemplary embodiment, inclined circular member 32464 and the spherical member may be attached to each other and block first inlet hole 3242. In an exemplary embodiment, fifth floating valve 3246e may include an internal water passage way which may provide first inlet hole 3242 with a straight water passage way.

As further shown in FIG. 3A, in an exemplary embodiment, hot water reservoir 144 may be mounted detachably onto boiler reservoir 122 by utilizing a second connecting mechanism 304. FIG. 3J shows an exploded view of second connecting mechanism 304, consistent with one or more exemplary embodiments of the present disclosure. As shown in FIG. 3J, in an exemplary embodiment, second connecting mechanism 304 may include a second poppet valve mechanism 342 provided at a bottom end 1444 of hot water reservoir 144. In an exemplary embodiment, second poppet valve mechanism 342 may include a second outlet hole 3422 provided at bottom end 1444 of hot water reservoir 144. In an exemplary embodiment, second poppet valve mechanism 342 may further include a second plunger 3424 disposed slidably inside second outlet hole 3422. In an exemplary embodiment, second plunger 3424 may include a second plunger disk 3425 at a top end of second plunger 3424, a third flexible gasket 3428 attached to it, and a second plunger rod 3426 at a bottom end of second plunger 3424. In an exemplary embodiment, second plunger rod 3426 may be guided by a hole provided at a bottom end 1444 of hot water reservoir 144 around which a plurality of openings are located, allowing water pass through them whenever second plunger 3424 is moved upwardly.

In an exemplary embodiment, second plunger disk 3425 may be configured to block second outlet hole 3422 through squeezing third flexible gasket 3428. In an exemplary embodiment, second plunger disk 3425 may apply a force to third flexible gasket 3428 and, to thereby, squeeze third flexible gasket 3428 which may cause blockage of second outlet hole 3422 as third flexible gasket 3428 may act as a sealing mechanism. In an exemplary embodiment, when second outlet hole 3422 is blocked, water discharge from hot water reservoir 144 and through second outlet hole 3422 may be prevented. In an exemplary embodiment, second plunger disk 3425 may further be configured to unblock second outlet hole 3422 when second plunger disk 3425 is moved upwardly inside second outlet hole 3422. In an exemplary embodiment, when second plunger disk 3425 is moved upwardly inside second outlet hole 3422, fluid communication may be provided between two sides of second outlet hole 3422. In an exemplary embodiment, when second outlet hole 3422 is unblocked, water may be discharged from hot water reservoir 144 and through second outlet hole 3422.

In an exemplary embodiment, second poppet valve mechanism 342 may further include a second retaining spring 3427 disposed between bottom end 1444 of hot water reservoir 144 and bottom end of second plunger 3424 using a retainer such as a retaining ring 3429. In an exemplary embodiment, second retaining spring 3427 may be configured to urge second plunger 3424 to move downward. In an exemplary embodiment, second retaining spring 3427 may apply a downward force to retaining ring 3429 and, to thereby, urge second plunger 3424 to move downward. For purpose of reference, it may be understood that in absence of an external force, second retaining spring 3427 may urge second plunger 3424 to retain second plunger's 3424 initial position and, to thereby, block second outlet hole 3422. In an exemplary embodiment, second connecting mechanism 304 may further include a trigger mechanism 344 provided at top end 128 of boiler reservoir 122. In an exemplary embodiment, trigger mechanism 344 may include a second inlet hole 3442 provided at a top end 128 of boiler reservoir 122. In an exemplary embodiment, second inlet hole 3442 may be associated with second outlet hole 3422. In an exemplary embodiment, when hot water reservoir 144 is mounted onto boiler reservoir 122, second inlet hole 3442 and second outlet hole 3422 may be aligned and sealed with each other using a fourth flexible gasket 3448 and, to thereby, water may be discharged from hot water reservoir 144 into boiler reservoir 122. In an exemplary embodiment, trigger mechanism 344 may further include a second trigger rod 3444 attached to top end 128 of boiler reservoir 122. In an exemplary embodiment, second trigger rod 3444 may be associated with second plunger rod 3426. In an exemplary embodiment, when hot water reservoir 144 is mounted onto boiler reservoir 122, second trigger rod 3444 may push second plunger rod 3426 upwardly and, to thereby, may urge second plunger 3424 to overcome the spring force and move upwardly inside second outlet hole 3422. In an exemplary embodiment, it may be understood that when second plunger 3424 is moved upwardly inside second outlet hole 3422, second outlet hole 3422 may be unblocked and water may be discharged from/to boiler reservoir 122 to/from hot water reservoir 144. In an exemplary embodiment, a top end of boiler reservoir 122 may include a plurality of openings surrounding second trigger rod 3444 which may allow water pass through them and enter boiler reservoir 122. In an exemplary embodiment, second connecting mechanism 304 may provide significant benefits. For example, by utilizing second connecting mechanism 304, water may be discharged from bottom end 1444 of hot water reservoir 144 just when hot water reservoir 144 is mounted onto boiler reservoir 122.

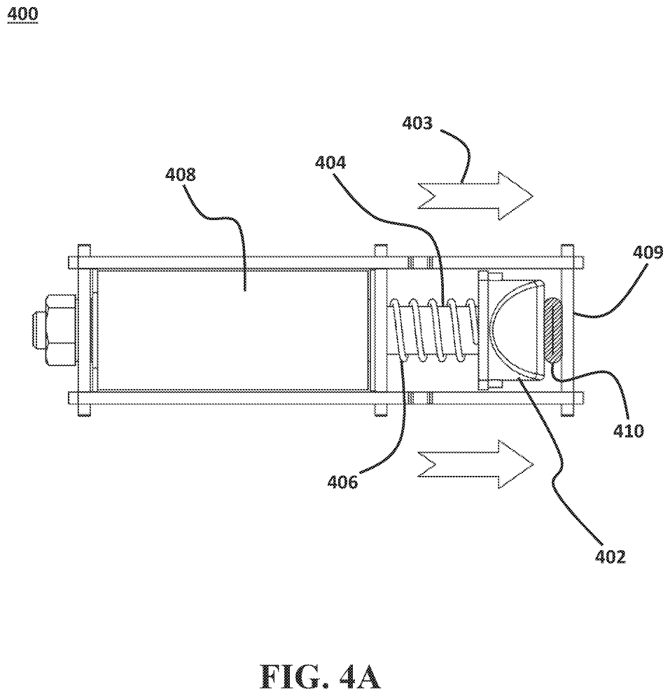

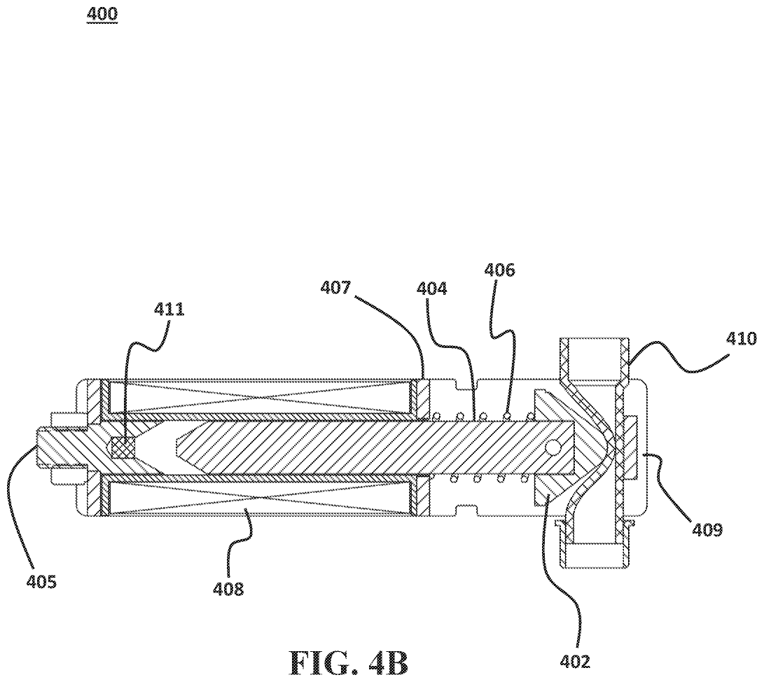

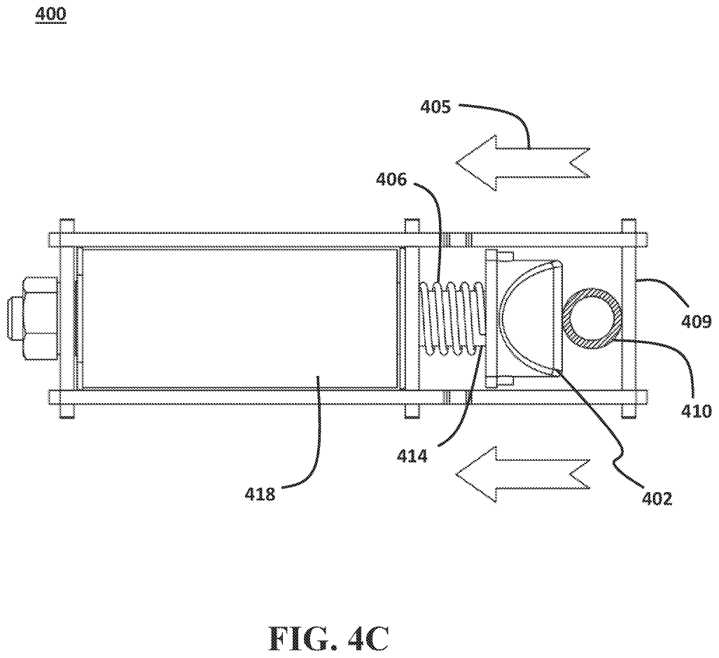

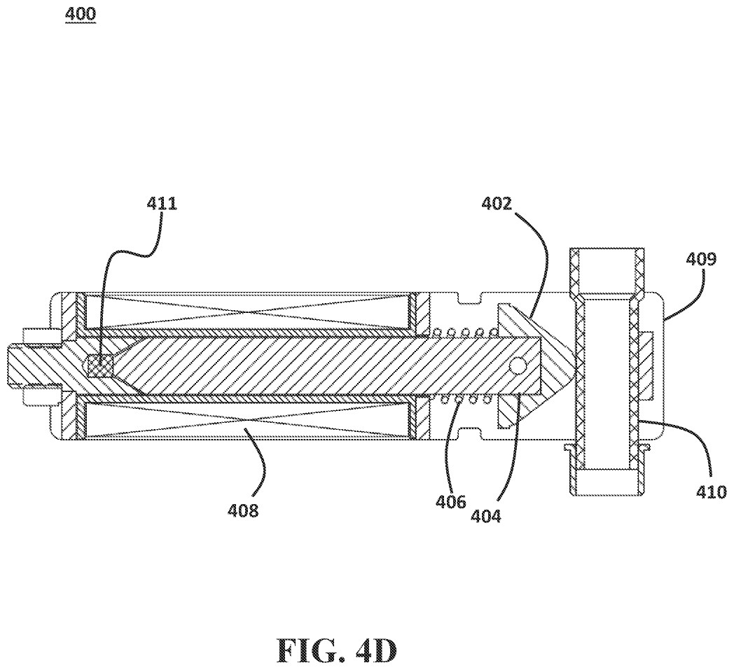

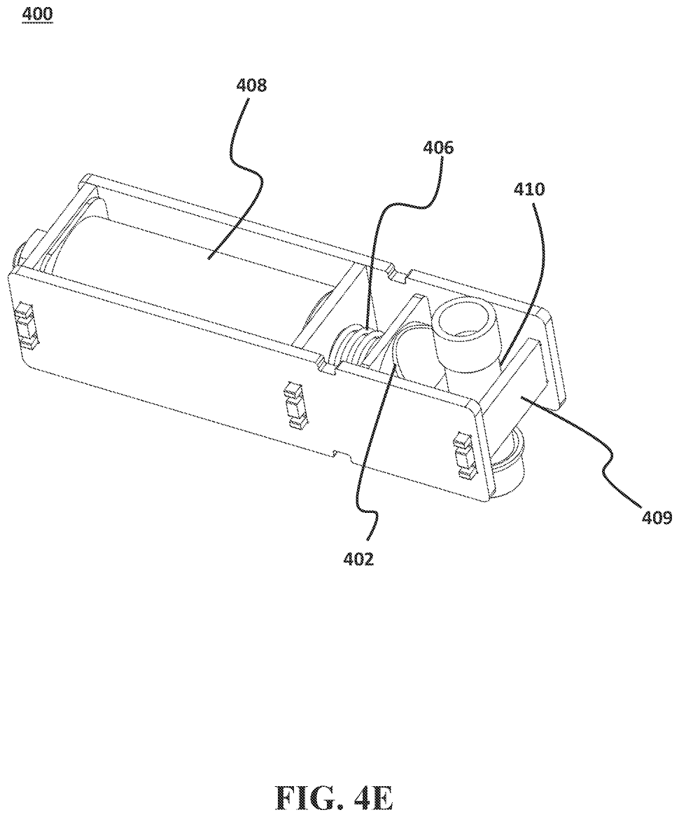

FIG. 4A shows a side view of pinch valve mechanism 400 in a first scenario in which pinch valve mechanism 400 is closed, consistent with one or more exemplary embodiments of the present disclosure. FIG. 4B shows a section view of pinch valve mechanism 400 in the first scenario in which pinch valve mechanism 400 is closed, consistent with one or more exemplary embodiments of the present disclosure. FIG. 4C shows pinch valve mechanism 400 in a second scenario in which pinch valve mechanism 400 is open, consistent with one or more exemplary embodiments of the present disclosure. FIG. 4D shows pinch valve mechanism 400 in the second scenario in which pinch valve mechanism 400 is open, consistent with one or more exemplary embodiments of the present disclosure. FIG. 4E shows a perspective view of pinch valve mechanism 400, consistent with one or more exemplary embodiments of the present disclosure. In an exemplary embodiment, when pinch valve mechanism 400 is closed, it may mean that pinch valve mechanism 400 blocks a flexible tube 410 which is disposed inside pinch valve mechanism 400. In an exemplary embodiment, when pinch valve mechanism 400 blocks flexible tube 410, water may not be able to pass through flexible tube 410. In an exemplary embodiment, when pinch valve mechanism 400 is open, it may mean that pinch valve mechanism 400 does not block flexible tube 410. In an exemplary embodiment, when pinch valve mechanism 400 does not block flexible tube 410, water may be able to pass through flexible tube 410. In an exemplary embodiment, pinch valve mechanism 400 may be used in structure of first discharge faucet 1262 and/or second discharge faucet 1272.

In an exemplary embodiment, pinch valve mechanism 400 may include a push member 402, a pinch plunger 404, a magnetic member 405, a pinch spring 406, a solenoid frame 407, a solenoid 408, and a frame 409. In an exemplary embodiment, push member 402 may include an edge 422. In an exemplary embodiment, push member 402 may be disposed inside frame 409 in such a way that edge 422 of push member 402 is in contact with flexible tube 410. In an exemplary embodiment, push member 402 may be configured to secure a flexible tube 410 between push member 402 and frame 409. In an exemplary embodiment, push member 402 may be attached to a distal end 442 of pinch plunger 404. In an exemplary embodiment, push member 402 may apply a force to flexible tube 410 to secure flexible tube between push member 402 and frame 409. In an exemplary embodiment, pinch plunger 404 may be a cylindrical member which may be interconnected between push member 402 and solenoid 408. In an exemplary embodiment, pinch spring 406 may be a linear spring which may be wrapped around pinch plunger 404. In an exemplary embodiment, pinch spring 406 may be disposed between push member 402 and solenoid frame 407. In an exemplary embodiment, pinch spring 406 may push member 402 in a first direction 403, and, to thereby, block flexible tube 410. In an exemplary embodiment, when energized, solenoid 408 may overcome the spring force and urge pinch plunger 404 to move in a second direction 455 and, to thereby, unblock flexible tube 410. In an exemplary embodiment, second direction 455 may be opposite to first direction 403. For purpose of reference, it may be understood that when solenoid 408 is deenergized and does not urge pinch plunger 404 to move in second direction 455, flexible tube 410 may be blocked and water may not be allowed to pass through flexible tube 410. And also, when solenoid 408 urges pinch plunger 404 to move in second direction 455, flexible tube 410 may be unblocked and water may be allowed to pass through flexible tube 410. In an exemplary embodiment, pinch valve mechanism 400 may further include a damping member 411. In an exemplary embodiment, damping member 411 may be disposed at a first end of pinch valve mechanism 400 inside magnetic member 405. In an exemplary embodiment, damping member 411 may be configured to minimize or otherwise reduce noise and shock during movement of pinch plunger 404. In an exemplary embodiment, damping member 411 may be made of a damping material such as rubber which may lower radiated noise and increase the transmission loss of the material. In an exemplary embodiment, pinch plunger 404, magnetic member 405, solenoid frame 407, and frame 409 may be made of magnetic materials such as low carbon steel. Thus, in an exemplary embodiment, the magnetic field caused by energizing solenoid 408 may result in the attraction of pinch plunger 404 by magnetic member 405 in second direction 455.

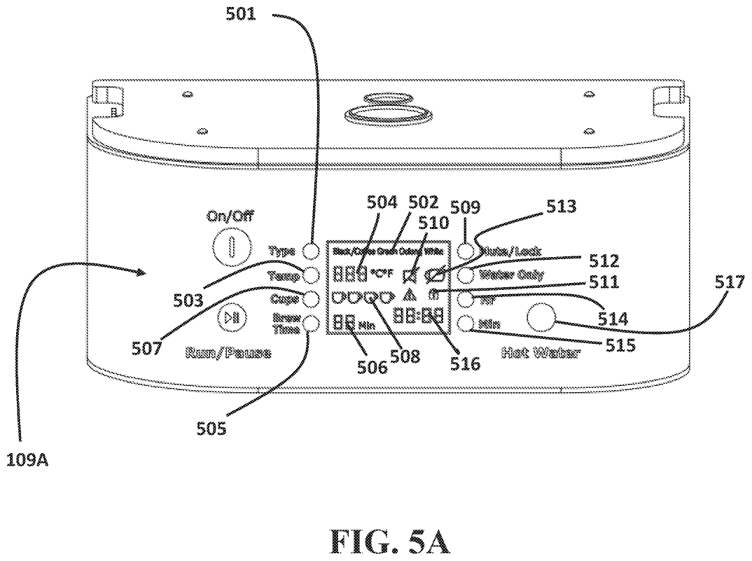

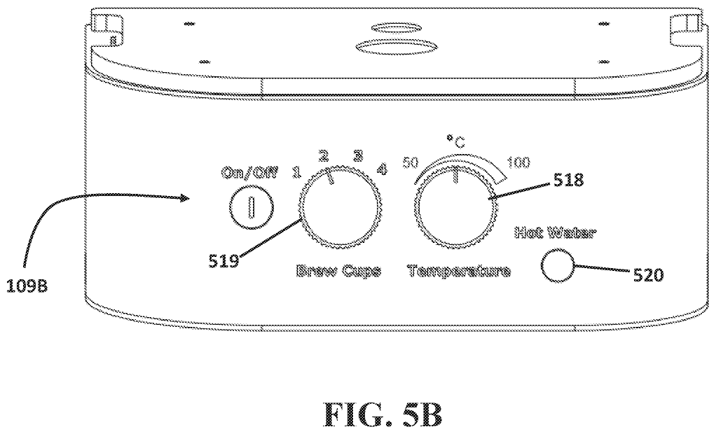

FIG. 5A shows a front view of a user interface of combined hot water dispenser and beverage 100 brewer with a fully electronic user interface and control section, consistent with one or more exemplary embodiments of the present disclosure. FIG. 5B shows a front view of a user interface of combined hot water dispenser and beverage brewer 100 with an electromechanical user interface and control section, consistent with one or more exemplary embodiments of the present disclosure. In an exemplary embodiment, combined hot water dispenser and beverage brewer 100 may further include a controller associated with user interfaces. In an exemplary embodiment, the controller may be in connection with heating element 123, adjustable thermostat 125, first temperature sensor 305, beverage heating mechanism 163, second temperature sensor 1633 first micro switch 1210, second micro switch mechanism 1625, first discharge faucet 1262, second discharge faucet 1272, light sources 354, 364, 372, 374, and an alarm.

As shown in FIG. 5A and FIG. 5B, in an exemplary embodiment, combined hot water dispenser and beverage brewer 100 may further include a user interface 109. In an exemplary embodiment, user interface 109 may be in connection with the controller. In an exemplary embodiment, user interface 109 may be configured to receive commands from a user and transmit control data to the controller. In an exemplary embodiment, the controller may be configured to control heating element 123, beverage heating mechanism 163, first discharge faucet 1262, and second discharge faucet 1272, light sources 354, 364, 372, 374, and the alarm. In an exemplary embodiment, the controller may be configured to receive feedbacks, data, and Commands from user interface 109, first temperature sensor 305, second temperature sensor 1633, first micro switch 1210, and second micro switch 1625.

In an exemplary embodiment, as shown in FIG. 5A, user interface 109A may be fully electronic which may be able to switch on/off heaters, light sources, first discharge faucet 1262, second discharge faucet 1272, and the alarm using electronic devices and on a closed-loop basis making use of feedbacks received from temperature sensors and micro switches. In this embodiment, a screen may be used to exhibit adjustments made by user using numbers, figures, and icons. In an exemplary embodiment, in order to receive these adjustments from a user, a plurality of push buttons may be provided around the screen. In an exemplary embodiment, functions of each push button from the plurality of push buttons may be determined by some words printed next to the each push button.

In an exemplary embodiment, a first push button 501 may be used to select beverage type which may be shown on a first section 502 of the screen. For example, black tea, coffee, green tea, white tea, oolong tea or other types of beverages may be predefined for the controller in a separate program, be shown on first section 502 and be chosen by a user. In an exemplary embodiment, every brewing program may involve its specific brewing temperature and time which may save the user's time during the adjustment of brewing conditions.

In an exemplary embodiment, a second push button 503 may be used to choose the water and brewing temperature, according to user's desire, which may be shown on a second section 504 of the screen. Moreover, in an exemplary embodiment, brew time may be chosen using a third push button 505 which may be exhibited on a third section 506 of the screen.

In an exemplary embodiment, the volume of water used for brewing may be chosen by a fourth push button 507 which may be exhibited on a fourth section 508 of the screen, by cop icons or any other units and/or shapes. In this embodiment, the controller may receive the number of required cups for steeping and may open first discharge faucet 1262 for a period of time during which desired volume of water may be discharged into beverage container 1630.

In an exemplary embodiment, a fifth push button 509 may be used to mute the apparatus which may prevent the alarm from informing a user of the completion of brewing process and a first icon 510 may indicate this silent mode. In an exemplary embodiment, pressing and holding fifth push button 509 for a period of time may also lock all buttons for safety reasons which may be indicated using a lock icon 511 on the screen.

In an exemplary embodiment, a sixth push button 512 may be used to select “water only mode” which may prevent the controller from triggering first discharge faucet 1262 and a second icon 513 may indicate this mode.

In an exemplary embodiment, a seventh push button 514 and an eighth push button 515 may be used to adjust the hour and minute for a timer to indicate the beginning of a brewing process which may be shown on a section 516 on the screen. In an exemplary embodiment, a ninth push button 517 may be used to trigger second discharge faucet 1272 to permit hot water to be released into water container 1650.

In an exemplary embodiment, as shown in FIG. 5B, user interface 109B may be electromechanical. For example, water temperature may be controlled using an adjustable bimetal or thermostat which may perform a closed-loop control by mechanical feedback sensed by its probe, which may be installed inside or outside of boiler reservoir 122. In an exemplary embodiment, the adjustment of water temperature may be made by a user using a rotary or linear switch 518 which may be installed on user interface section 109B. In an exemplary embodiment, the number of brew cups may also be determined by a user using a selector 519 which may be rotary or linear. In an exemplary embodiment, a tenth push button 520 may be used to trigger second discharge faucet 1272 to permit hot water to be released into water container 1650.

Disclosed above is combined hot water dispenser and beverage brewer 100 for combined hot water dispensing and beverage brewing. As discussed above, it may be understood that utilizing combined hot water dispenser and beverage brewer 100 may provide significant benefits including, but not limited to, the following items. A user may be able to brew a specific kind of beverage by controlling the length of the steeping period and also the water temperature. A user may be able to determine the needed volume of water and, consequently, unnecessary energy may not be consumed through heating up an extra amount of water. Furthermore, the whole water inside cold water reservoir 142 may not be boiled for many times and, consequently, the water quality may not degrade. A user may be able to easily detach cold water reservoir 142 and hot water reservoir 144 and then clean or disinfect cold water reservoir 142 and hot water reservoir 144. In an exemplary embodiment, a high capacity water storage may be used as cold water reservoir 142 due to the easy attachment and detachment of cold water reservoir 142. A user may be able to add water to cold water reservoir 142 whenever is needed even during water heating in boiler reservoir 122 and/or water discharge from first discharge faucet 1262 and/or second discharge faucet 1272.

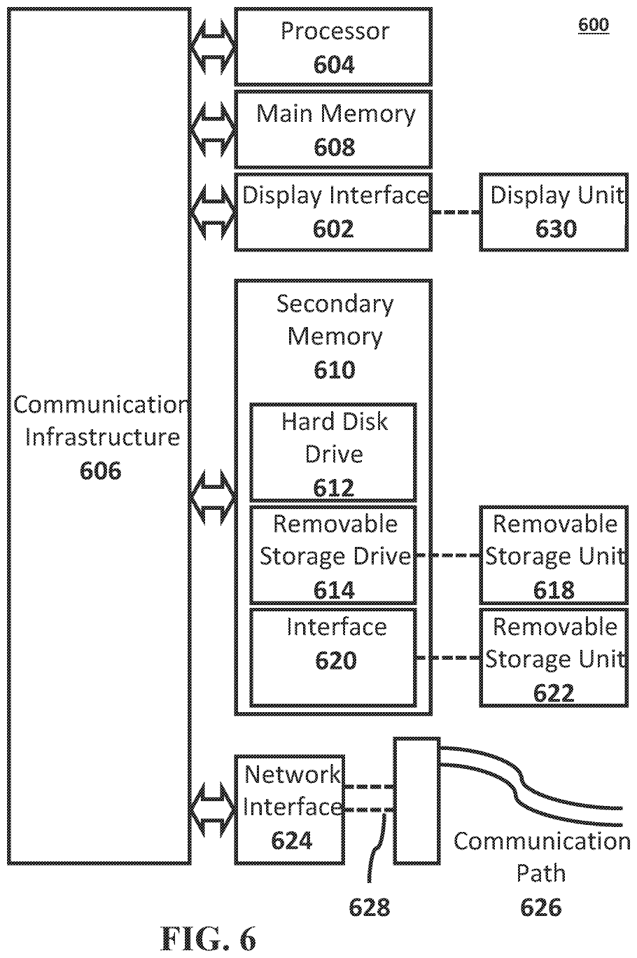

FIG. 6 shows an example computer system 600 in which an embodiment of the present disclosure, or portions thereof, may be implemented as computer-readable code, consistent with exemplary embodiments of the present disclosure. For example, a processor may be implemented in computer system 600 using hardware, software, firmware, tangible computer readable media having instructions stored thereon, or a combination thereof and may be implemented in one or more computer systems or other processing systems.

If programmable logic is used, such logic may execute on a commercially available processing platform or a special purpose device. One ordinary skill in the art may appreciate that an embodiment of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

For instance, a computing device having at least one processor device and a memory may be used to implement the above-described embodiments. A processor device may be a single processor, a plurality of processors, or combinations thereof. Processor devices may have one or more processor “cores.”

An embodiment of the disclosure is described in terms of this example computer system 600. After reading this description, it will become apparent to a person skilled in the relevant art how to implement the disclosure using other computer systems and/or computer architectures. Although operations may be described as a sequential process, some of the operations may in fact be performed in parallel, concurrently, and/or in a distributed environment, and with program code stored locally or remotely for access by single or multiprocessor machines. In addition, in some embodiments the order of operations may be rearranged without departing from the spirit of the disclosed subject matter.

Processor device 604 may be a special purpose or a general-purpose processor device. As will be appreciated by persons skilled in the relevant art, processor device 604 may also be a single processor in a multi-core/multiprocessor system, such system operating alone, or in a cluster of computing devices operating in a cluster or server farm. Processor device 604 may be connected to a communication infrastructure 606, for example, a bus, message queue, network, or multi-core message-passing scheme.

In an exemplary embodiment, computer system 600 may include a display interface 602, for example a video connector, to transfer data to a display unit 630, for example, a monitor. Computer system 600 may also include a main memory 608, for example, random access memory (RAM), and may also include a secondary memory 610. Secondary memory 610 may include, for example, a hard disk drive 612, and a removable storage drive 614. Removable storage drive 614 may include a floppy disk drive, a magnetic tape drive, an optical disk drive, a flash memory, or the like. Removable storage drive 614 may read from and/or write to a removable storage unit 618 in a well-known manner. Removable storage unit 618 may include a floppy disk, a magnetic tape, an optical disk, etc., which may be read by and written to by removable storage drive 614. As will be appreciated by persons skilled in the relevant art, removable storage unit 618 may include a computer usable storage medium having stored therein computer software and/or data.

In alternative implementations, secondary memory 610 may include other similar means for allowing computer programs or other instructions to be loaded into computer system 600. Such means may include, for example, a removable storage unit 622 and an interface 620. Examples of such means may include a program cartridge and cartridge interface (such as that found in video game devices), a removable memory chip (such as an EPROM, or PROM) and associated socket, and other removable storage units 622 and interfaces 620 which allow software and data to be transferred from removable storage unit 622 to computer system 600.

Computer system 600 may also include a communications interface 624. Communications interface 624 allows software and data to be transferred between computer system 600 and external devices. Communications interface 624 may include a modem, a network interface (such as an Ethernet card), a communications port, a PCMCIA slot and card, or the like. Software and data transferred via communications interface 624 may be in the form of signals, which may be electronic, electromagnetic, optical, or other signals capable of being received by communications interface 624. These signals may be provided to communications interface 624 via a communications path 626. Communications path 626 carries signals and may be implemented using wire or cable, fiber optics, a phone line, a cellular phone link, an RF link or other communications channels.

In this document, the terms “computer program medium” and “computer usable medium” are used to generally refer to media such as removable storage unit 618, removable storage unit 622, and a hard disk installed in hard disk drive 612. Computer program medium and computer usable medium may also refer to memories, such as main memory 608 and secondary memory 610, which may be memory semiconductors (e.g. DRAMs, etc.).

Computer programs (also called computer control logic) are stored in main memory 608 and/or secondary memory 610. Computer programs may also be received via communications interface 624. Such computer programs, when executed, enable computer system 600 to implement different embodiments of the present disclosure as discussed herein. In particular, the computer programs, when executed, enable processor device 604 to implement the processes of the present disclosure. Accordingly, such computer programs represent controllers of computer system 600. The software may be stored in a computer program product and loaded into computer system 600 using removable storage drive 614, interface 620, and hard disk drive 612, or communications interface 624.

Embodiments of the present disclosure also may be directed to computer program products including software stored on any computer useable medium. Such software, when executed in one or more data processing device, causes a data processing device to operate as described herein. An embodiment of the present disclosure may employ any computer useable or readable medium. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.).

While the foregoing has described what may be considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective spaces of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various implementations. This is for purposes of streamlining the disclosure, and is not to be interpreted as reflecting an intention that the claimed implementations require more features than are expressly recited in each claim. Rather, as the following claims reflect, inventive subject matter lies in less than all features of a single disclosed implementation. Thus, the following claims are hereby incorporated into the Detailed Description, with each claim standing on its own as a separately claimed subject matter.

While various implementations have been described, the description is intended to be exemplary, rather than limiting and it will be apparent to those of ordinary skill in the art that many more implementations and implementations are possible that are within the scope of the implementations. Although many possible combinations of features are shown in the accompanying figures and discussed in this detailed description, many other combinations of the disclosed features are possible. Any feature of any implementation may be used in combination with or substituted for any other feature or element in any other implementation unless specifically restricted. Therefore, it will be understood that any of the features shown and/or discussed in the present disclosure may be implemented together in any suitable combination. Accordingly, the implementations are not to be restricted except in light of the attached claims and their equivalents. Also, various modifications and changes may be made within the scope of the attached claims.

What is claimed is:

1- A combined hot water dispenser and beverage brewer, comprising:
a water heating section, comprising:
a boiler reservoir configured to receive and store water;
a heating element disposed inside the boiler reservoir, the heating element configured to heat water inside the boiler reservoir; and
a first water discharge mechanism configured to discharge water from the boiler reservoir, the first water discharge mechanism comprising:
a first discharge faucet disposed under the boiler reservoir;
a first discharge tube, a bottom end of the first discharge tube connected to the first discharge faucet, a top end of the first discharge tube disposed at a top end of the boiler reservoir, the first discharge faucet configured to allow water discharge from the top end of the boiler reservoir and through the first discharge tube; and
a water storage section, comprising:
a cold water reservoir configured to receive and store water, the cold water reservoir disposed above the boiler reservoir, the cold water reservoir in fluid communication with a bottom end of the boiler reservoir through a cold water tube;
a hot water reservoir configured to receive and store water, the hot water reservoir in fluid communication with the top end of the boiler reservoir through a hot water inlet, the hot water reservoir disposed above the boiler reservoir.

2- The combined hot water dispenser and beverage brewer of claim 1, wherein the water heating section further comprises a second water discharge mechanism configured to discharge water from the boiler reservoir, the water discharge mechanism comprising:
a second discharge faucet disposed under the boiler reservoir;
a second discharge tube, a bottom end of the second discharge tube attached to the second discharge faucet, a bottom end of the second discharge tube disposed at a top end of the boiler reservoir, the second discharge faucet configured to allow water discharge from the top end of the boiler reservoir and through the second discharge tube.

3- The combined hot water dispenser and beverage brewer of claim 2, further comprising a delivery section disposed under the water heating section, the delivery section comprising:
a beverage brewing section associated with the first water discharge mechanism, the beverage brewing section disposed under the first discharge faucet, the beverage brewing section comprising a beverage heating mechanism, the beverage heating mechanism configured to:
receive a beverage container;
secure the beverage container under the first discharge faucet; and
heat the beverage container;
wherein the first discharge faucet is configured to allow water discharge from the top end of the boiler reservoir and through the first discharge tube into the beverage container; and
a hot water delivery section associated with the second water discharge mechanism, the hot water delivery section disposed under the second discharge faucet, the hot water delivery section comprising a water container holding member, the water container holding member configured to:
receive a water container;
store waste water; and
secure the water container under the second discharge faucet;
wherein the second discharge faucet is configured to allow water discharge from the top end of the boiler reservoir and through the second discharge tube into the water container.

4- The combined hot water dispenser and beverage brewer of claim 3, wherein the cold water reservoir is configured to be mounted detachably onto the boiler reservoir utilizing a first connecting mechanism, the first connecting mechanism comprising:
a first poppet valve mechanism provided at a bottom end of the cold water reservoir, the first poppet valve mechanism comprising:
a first outlet hole provided at the bottom end of the cold water reservoir;
a first plunger disposed slidably inside the first outlet hole, the first plunger comprising a first plunger disk at a top end of the first plunger along with a first flexible gasket attached to the first plunger disk and a first plunger rod at a bottom of the first plunger, the first plunger disk configured to:
block the first outlet hole and prevent water discharge from the cold water reservoir and through the first outlet hole by blocking the first outlet hole; and
unblock the first outlet hole and allow water discharge from the cold water reservoir and through the first outlet hole by unblocking the first outlet responsive to upward movement of the first plunger inside the first outlet hole; and
a first spring disposed between the bottom end of the cold water reservoir and the bottom end of the first plunger rod, the first spring configured to urge the first plunger to move downward;
a first retaining ring configured to connect the lower side of the first plunger rod to the lower end of the first spring; and
a buoyancy valve mechanism provided at top end of the boiler reservoir, the buoyancy valve mechanism comprising:
a first inlet hole provided at a top end of the boiler reservoir, the first inlet hole associated with the first outlet hole, a top end of the cold water tube connected to the first inlet hole, the first inlet hole and the first outlet hole configured to be aligned and sealed with each other using a first flexible gasket and, to thereby, allow water discharge from the cold water reservoir into the cold water tube responsive to mounting the cold water reservoir onto the boiler reservoir; and
a first trigger rod attached to the top end of the boiler reservoir, the first trigger rod associated with the first plunger rod, the first trigger rod configured to push the first plunger rod upwardly and, to thereby, urge the first plunger to overcome the first spring force and move upwardly inside the first outlet hole responsive to mounting the cold water reservoir onto the boiler reservoir.

5- The combined hot water dispenser and beverage brewer of claim 4, wherein the first connecting mechanism further comprises a floating valve disposed slidably inside the first inlet hole, the floating valve comprising:
a valve disk at a top end of the floating valve;
an empty cavity configured to store air; and
a guide bushing at its inner side;
wherein the floating valve is configured to:
move downward and allow water discharge from an upper side of the first inlet hole to a lower side of the first inlet hole by moving the floating valve downward responsive to the absence of water inside the boiler reservoir and the first inlet hole; and
move upward and, thereby, the valve disk blocking the first inlet hole and, to thereby, prevent water discharge from the lower side of the first inlet hole to the upper side of the first inlet hole responsive to the presence of water inside the boiler reservoir and the first inlet hole due to a buoyancy principle.

6- The combined hot water dispenser and beverage brewer of claim 5, wherein the cold water tube comprises a helical tube, a top end of the helical tube connected to the first inlet hole, a bottom end of the helical tube disposed at the bottom end of the boiler reservoir.

7- The combined hot water dispenser and beverage brewer of claim 6, wherein the heating element is disposed at the bottom end of the boiler reservoir.

8- The combined hot water dispenser and beverage brewer of claim 7, wherein the water heating section further comprises an adjustable thermostat in electrical connection with the heating element, the adjustable thermostat configured to control water temperature by turning off the heating element responsive to the heating element's temperature being more than a threshold.

9- The combined hot water dispenser and beverage brewer of claim 8 further comprising a first temperature sensor configured to send a first temperature feedback to the controller, the first temperature feedback associated with the water temperature inside the boiler reservoir, the controller configured to switch on and/or switch off the heating element based on the first temperature feedback to achieve a precise water temperature in the boiler reservoir on a closed-loop basis.

10- The combined hot water dispenser and beverage brewer of claim 9 further comprising a second temperature sensor, the second temperature sensor configured to send a second temperature feedback to the controller, the second temperature feedback associated with the beverage heating mechanism, the controller configured to switch on and switch off the heating element based on the second temperature feedback so as to achieve a precise beverage temperature.

11- The combined hot water dispenser and beverage brewer of claim 10, wherein the hot water reservoir is configured to be mounted detachably onto the boiler reservoir utilizing a second connecting mechanism, the second connecting mechanism comprising:
a second poppet valve mechanism provided at a bottom end of the hot water reservoir, the second poppet valve mechanism comprising:
a second outlet hole provided at the bottom end of the hot water reservoir;
a second plunger disposed slidably inside the second outlet hole, the second plunger comprising a second plunger disk at a top end of the second plunger along with a second flexible gasket attached to the second plunger disk and a second plunger rod at a bottom end of the second plunger, the second plunger disk configured to:
block the second outlet hole and, to thereby, prevent water discharge from the hot water reservoir and through the second outlet hole; and
unblock the second outlet hole and, to thereby, allow water discharge from the hot water reservoir and through the second outlet hole responsive to upward movement of the second plunger inside the second outlet hole; and
a second retaining spring disposed between the bottom end of the hot water reservoir and the bottom end of the second plunger rod, the second retaining spring configured to urge the second plunger to move downward; and
a second retaining ring configured to connect the lower end of the second plunger rod to the lower end of the spring; and
a trigger mechanism provided at a top end of the boiler reservoir, the trigger mechanism comprising:
a second inlet hole provided at a top end of the boiler reservoir, the second inlet hole associated with the second outlet hole, the second inlet hole and the second outlet hole configured to be aligned and sealed with each other and, to thereby, allow water discharge from the hot water reservoir into the boiler reservoir responsive to mounting the hot water reservoir onto the boiler reservoir; and
a second trigger rod attached to the top end of the boiler reservoir, the second trigger rod associated with the second plunger rod, the second trigger rod configured to push the second plunger rod upwardly and, to thereby, urge the second plunger to move upwardly inside the second outlet hole responsive to mounting the hot water reservoir onto the boiler reservoir.

12- The combined hot water dispenser and beverage brewer of claim 11, wherein the hot water reservoir is detachably disposed inside the cold water reservoir and is fixed with a rotary multi key fastener.

13- The combined hot water dispenser and beverage brewer of claim 12, wherein the first discharge faucet comprises a first pinch valve mechanism, the first pinch valve mechanism comprising:
a first frame;
a first magnetic part
a first push member, the first push member configured to secure a first flexible tube between the first push member and the first frame;
a first solenoid;
a first solenoid frame;
a first pinch plunger interconnected between the first push member and the first solenoid; the first solenoid configured to urge the first plunger to move; and
a first pinch spring disposed between the first push member and the first solenoid frame;
wherein:
the first pinch spring is configured to push the first push member in a first direction and, to thereby, block the first flexible tube;
the first solenoid is configured to urge the first plunger to move in a second direction and, to thereby, unblock the first flexible tube, the second direction being opposite to the first direction;
the second discharge faucet comprises a second pinch valve mechanism, the second pinch valve mechanism comprising:
a second frame;
a second magnetic part;
a second push member, the second push member configured to secure a second flexible tube between the second push member and the second frame;
a second solenoid;
a second solenoid frame;
a second pinch plunger interconnected between the second push member and the second solenoid; the second solenoid configured to urge the second plunger to move;
a second pinch spring disposed between the second push member and the second solenoid frame;
the second pinch spring is configured to push the second push member in a third direction and, to thereby, block the second flexible tube; and
the second solenoid is configured to urge the second plunger to move in a fourth direction and, to thereby, unblock the second flexible tube, the fourth direction being opposite to the third direction.

14- The combined hot water dispenser and beverage brewer of claim 13, further comprising a controller in connection with the heating element, the first temperature sensor, the second temperature sensor, the first micro switch, the second micro switch, the beverage heating mechanism, the first discharge faucet, the second discharge faucet, the first light source, the second light source, the third light source, and the fourth light source along with an alarm, the controller configured to control the heating element, the beverage heating mechanism, the first discharge faucet, the second discharge faucet, the first light source, the second light source, the third light source, the fourth light source, and the alarm.

15- The combined hot water dispenser and beverage brewer of claim 14, further comprising a user interface, the user interface configured to receive commands from a user and transmit control data to the controller and exhibit adjustments made by the user, wherein the controller is configured to control the heating element, the beverage heating mechanism, the first discharge faucet, the second discharge faucet, the first light source, the second light source, the third light source, and the fourth light source along with the alarm based on feedbacks received from the first temperature sensor, the second temperature sensor, the first micro switch, the second micro switch, and adjustments done by the user through the user interface.

16- The combined hot water dispenser and beverage brewer of claim 14, further comprising a fully electronic user interface configured to switch on/off heaters, light sources, and the alarm using electronic devices and on a closed-loop basis making use of feedbacks received from temperature sensors and micro switches, the fully electronic user interface comprising:
a screen configured to exhibit adjustments made by the user using numbers, figures, and icons;
a first push button configured to select beverage type shown on a first section of the screen;
a second push button configured to choose the water and brewing temperature, according to the user's desire shown on a second section of the screen;
a third push button configured to choose brew time shown on a third section of the screen;
a fourth push button configured to choose a volume of water used for brewing shown on a fourth section of the screen by cop icons or any other units and/or shapes, the controller configured to receive a number of required cups for steeping and open the first discharge faucet for a period of time during which desired volume of water is discharged into the beverage container;
a fifth push button configured to mute the combined hot water dispenser and beverage brewer and prevent the alarm from informing the user of the completion of brewing process;
a first icon configured to indicate a silent mode;
a sixth push button configured to select a water only mode, responsive to selecting the water only mode, the controller being prevented from triggering the first discharge faucet
a second icon configured to indicate the water only mode;
a seventh push button and an eighth push button configured to respectively adjust an hour and a minute for a timer to indicate the beginning of a brewing process shown on a section of the screen; and
a ninth push button configured to trigger the second discharge faucet to permit hot water to be released into the water container.

17- The combined hot water dispenser and beverage brewer of claim 14, further comprising an electromechanical user interface, the electromechanical user interface comprising:
a rotary or linear switch installed on the user interface section, the rotary or linear switch configured to adjust water temperature;
a selector configured to determine a number of brew cups; and
a tenth push button configured to trigger the second discharge faucet to permit hot water to be released into the water container.

18- The combined hot water dispenser and beverage brewer of claim 15, wherein the beverage brewing section further comprises:
a first micro switch, the first micro switch configured to detect presence of the cold water reservoir mounted on the water heating section and transmit data to the controller based on the presence of the cold water reservoir; and
a second micro switch mechanism, the second micro switch mechanism configured to detect presence of the beverage container on the beverage heating mechanism and transmit data to the controller based on the presence of the beverage container.

19- The combined hot water dispenser and beverage brewer of claim 4, wherein the first connecting mechanism further comprises a first floating valve disposed slidably inside the first inlet hole, an inner surface of the first inlet hole configured to guide the first floating valve by utilizing a number of external ribs, the first floating valve comprising:
a valve disk at a top end of the floating valve;
a circular water passage way at an outer surface of the floating valve; and
an empty cavity configured to store air;
wherein the first floating valve is configured to:
move downward and, to thereby, allow water discharge from an upper side of the first inlet hole to a lower side of the first inlet hole responsive to the absence of water inside the boiler reservoir and the first inlet hole; and
move upward and, thereby, the valve disk blocking the first inlet hole and, to thereby, prevent water discharge from the lower side of the first inlet hole to the upper side of the first inlet hole responsive to the presence of water inside the boiler reservoir and the first inlet hole due to a buoyancy principle.

20- The combined hot water dispenser and beverage brewer of claim 4, wherein the first connecting mechanism further comprises a second floating valve disposed slidably inside the first inlet hole, the second floating valve comprising:
a spherical member disposed inside the first inlet hole, the spherical member defining a water passage way between the spherical member and an inner surface of the first inlet hole;
wherein the spherical member is configured to:
move downward and, to thereby, allow water discharge from an upper side of the first inlet hole to a lower side of the first inlet hole responsive to the absence of water inside the boiler reservoir and the first inlet hole; and
move upward and be attached to an inclined circular member and, thereby, the spherical member and the inclined circular member blocking the first inlet hole and, to thereby, prevent water discharge from the lower side of the first inlet hole to the upper side of the first inlet hole responsive to the presence of water inside the boiler reservoir and the first inlet hole due to a buoyancy principle.
